(19) United States
(12) Patent Application Publication
(10) Pub. No.: US 2025/0234228 A1
(43) Pub. Date: Jul. 17, 2025

(54) LOCATION-ASSISTANCE SIGNALING TO IMPROVE PERFORMANCE OF MINIMIZATION OF DRIVE TESTS

(71) Applicant: QUALCOMM Incorporated, San Diego, CA (US)

(72) Inventors: Akash KUMAR, Hyderabad (IN); Amit JAIN, San Diego, CA (US); Hargovind Prasad BANSAL, Bharatpur (IN)

(21) Appl. No.: 18/414,310

(22) Filed: Jan. 16, 2024

(51) Int. Cl. H04W 24/10; H04L 5/00

(52) U.S. Cl. CPC H04W 24/10; H04L 5/0048

(57) ABSTRACT

A network node may configure a minimization of drive test (MDT) configuration. The network node may transmit, for a user equipment (UE), the MDT configuration. The UE may obtain the minimization of drive test (MDT) configuration. The UE may calculate at least one of a location of the UE or an MDT uncertainty metric based on the MDT configuration. The UE may transmit at least one of a first indicator of the calculated location of the UE or a second indicator of the calculated MDT uncertainty metric. The network node may receive at least one of the first indicator of a location of the UE or the second indicator of the MDT uncertainty metric based on the MDT configuration.

### TECHNICAL FIELD

The present disclosure relates generally to communication systems, and more particularly, to a minimization of drive test (MDT) wireless device.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment (UE). The apparatus may obtain a minimization of drive test (MDT) configuration. The apparatus may calculate at least one of a location of the UE or an MDT uncertainty metric based on the MDT configuration. The apparatus may transmit at least one of a first indicator of the calculated location of the UE or a second indicator of the calculated MDT uncertainty metric.

In an aspect of the disclosure, a method, a computer-readable medium, and an apparatus are provided. The apparatus may include a network node. The apparatus may configure an MDT configuration. The apparatus may transmit, for another apparatus, such as a UE, the MDT configuration. The apparatus may receive at least one of a first indicator of a location of the UE or a second indicator of an MDT uncertainty metric based on the MDT configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on positioning signal measurements.

FIG. 5 is a diagram illustrating an example of a plurality of UEs configured to perform a minimization of drive test (MDT).

FIG. 6 is a connection flow diagram illustrating an example of location assistance signaling between a UE configured to perform an MDT and a network node.

FIG. 7 is a connection flow diagram illustrating an example of location assistance signaling between a UE configured to perform an MDT and a network node.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless network diagnostic systems. Some aspects more specifically relate to wireless devices configured to perform a minimization of drive test (MDT). In some examples, a user equipment (UE) may obtain a minimization of drive test (MDT) configuration, for example from a network node or by configuring the MDT configuration based on a sensitivity metric associated with the UE, a power headroom report (PHR) value associated with the UE, or a Doppler spread value associated with the UE. The UE may calculate at least one of a location of the UE or an MDT uncertainty metric based on the MDT configuration. The UE may transmit at least one of a first indicator of the calculated location of the UE or a second indicator of the calculated MDT uncertainty metric. In other examples, a network node may configure an MDT configuration. The network node may transmit, for UE, the MDT configuration. The network node may receive at least one of a first indicator of a location of the UE or a second indicator of an MDT uncertainty metric based on the MDT configuration.

In some aspects, a UE under MDT may be mobile. The UE under MDT may travel at such speeds that the location fix associated with the MDT report may be outdated. In other words, the measurements for the MDT report may be associated with a location that is not the last known location of the UE. In some aspects, a UE supporting MDT may be configured by a network to periodically perform location fixes based on observed RSRP values, a mobility metric of the UE, or some other indicator that the UE is moving at such speeds that the location fix associated with the MDT report may be outdated without such periodic fixes. In some aspects, a UE supporting MDT may autonomously (i.e., on its own) periodically perform location fixes based on Rx sensitivity, PHR value, Doppler spread, or some other indicator that the UE is moving at such speeds that the location fix associated with the MDT report may be outdated without such periodic fixes. In some aspects, a UE may report via an additional information element (IE), the time elapsed between the time when a configured event occurred and the time of the report. A network device (e.g., base station, location management function (LMF), core network) receiving such a report may configure the UE to periodically perform location fixes based on the information indicated in the IE.

Particular aspects of the subject matter described in this disclosure can be implemented to realize one or more of the following potential advantages. In some examples, by configuring a UE to periodically calculate its location in response to determining that the known location of the UE may not be relevant to the MDT measurements, the described techniques can be used to increase the frequency that the UE calculates its location under MDT as appropriate. The updated UE location information may be used by the network for better network planning and/or to tune the network configuration to provide improved network coverage and performance. Such networks may construct improved conformance tests for such UEs to check for validity/uncertainty of location information correlated with MDT reports to incentivize networks and original equipment manufacturers (OEMs) to meet location accuracy and uncertainty criteria. Such UEs may improve the performance of MDTs conducted by mobile UEs, and may enhance the overall performance of UEs in areas where MDTs are performed.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

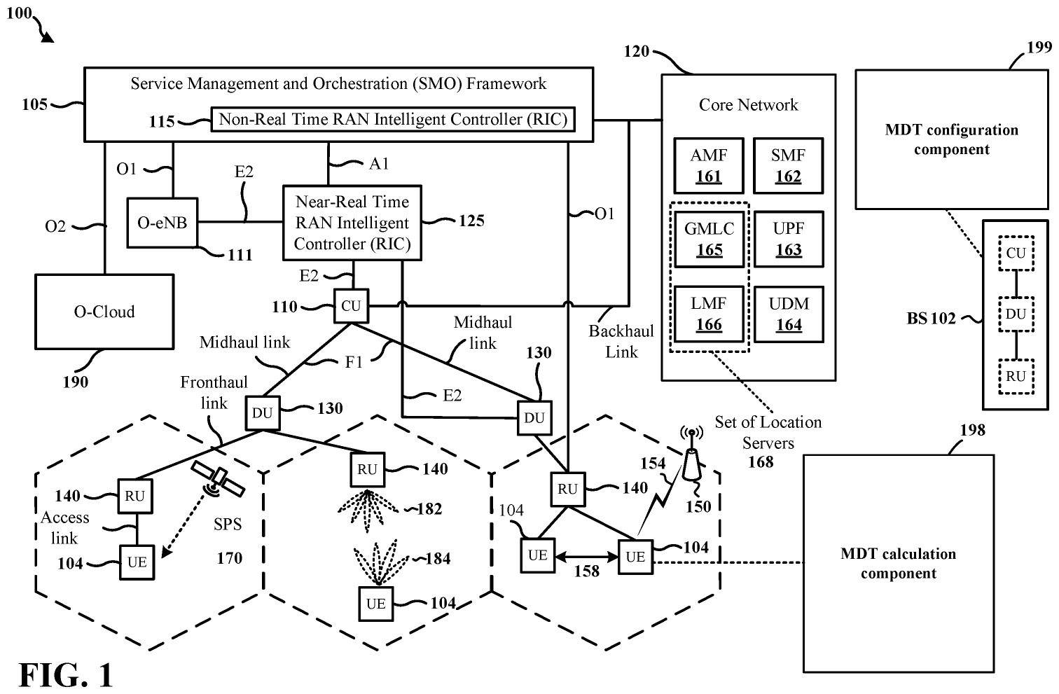

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an MDT calculation component 198 that may be configured to obtain an MDT configuration. The MDT calculation component 198 may be configured to calculate at least one of a location of the UE 104 or an MDT uncertainty metric based on the MDT configuration. The MDT calculation component 198 may be configured to transmit at least one of a first indicator of the calculated location of the UE 104 or a second indicator of the calculated MDT uncertainty metric. In certain aspects, the base station 102 may have an MDT configuration component 199 that may be configured to configure an MDT configuration. The MDT configuration component 199 may be configured to transmit, for the UE 104, the MDT configuration. The MDT configuration component 199 may be configured to receive at least one of a first indicator of a location of the UE 104 or a second indicator of an MDT uncertainty metric based on the MDT configuration. In other words, in one aspect, the MDT configuration component 199 may configure and transmit an MDT configuration for the MDT calculation component 198 to calculate its location more often in response to the UE 104 determining that a condition, as configured in the MDT configuration, has occurred. In another aspect, the MDT calculation component 198 may calculate an MDT uncertainty metric, and may transmit the calculated MDT uncertainty metric to the MDT configuration component 199. The MDT configuration component 199 may then configure an MDT configuration based on the received MDT uncertainty metric.

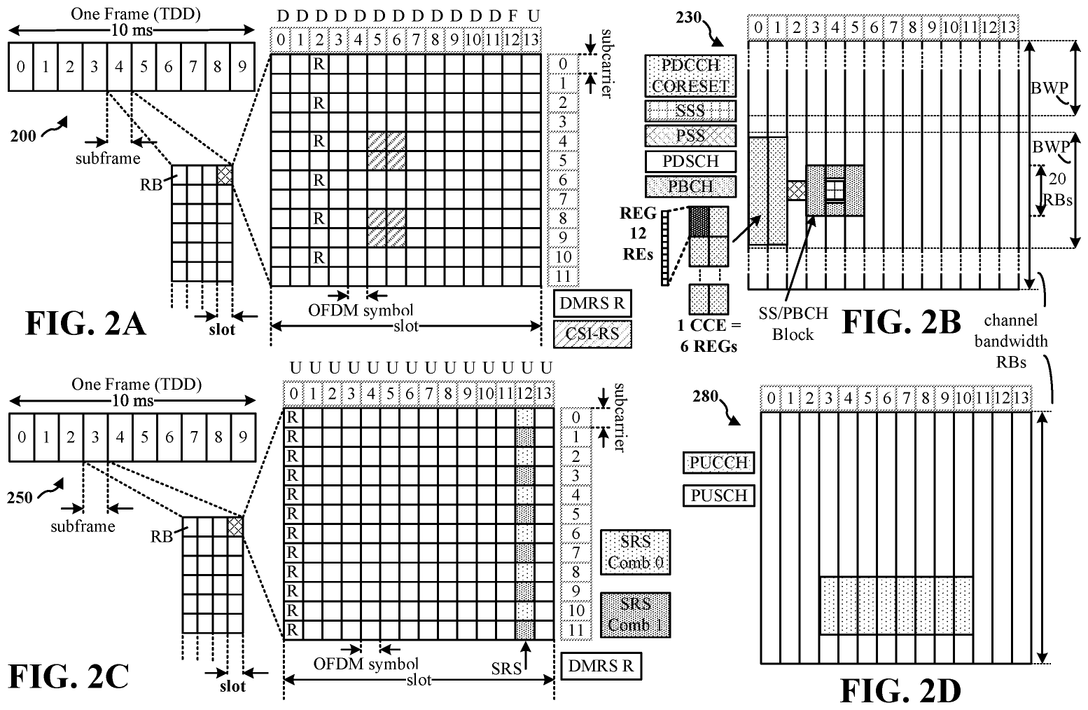

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δƒ = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 24^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

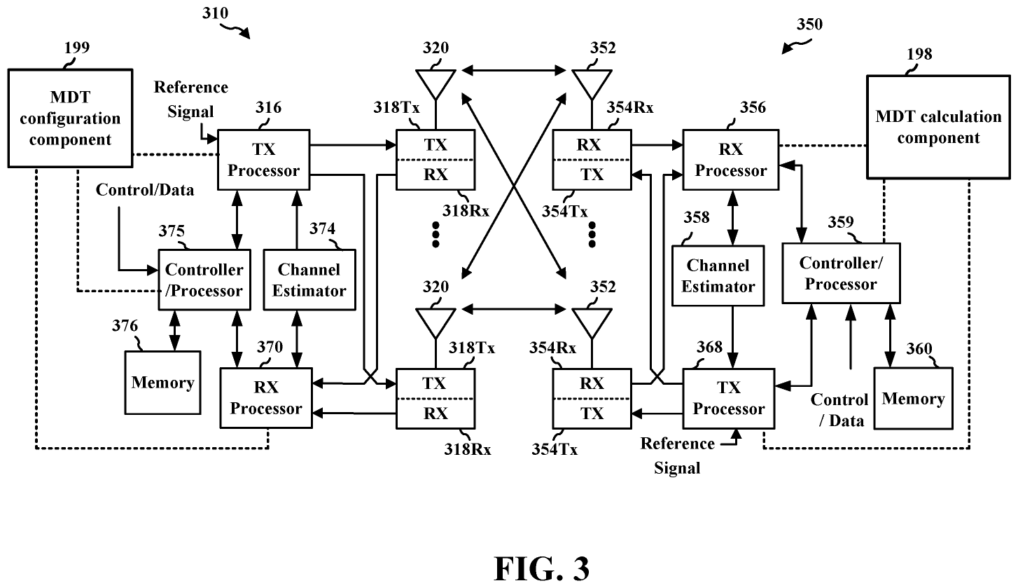

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the MDT calculation component 198 of FIG. 1.

At least one of the TX processor 316, the RX processor 370, and the controller/processor 375 may be configured to perform aspects in connection with the MDT configuration component 199 of FIG. 1.

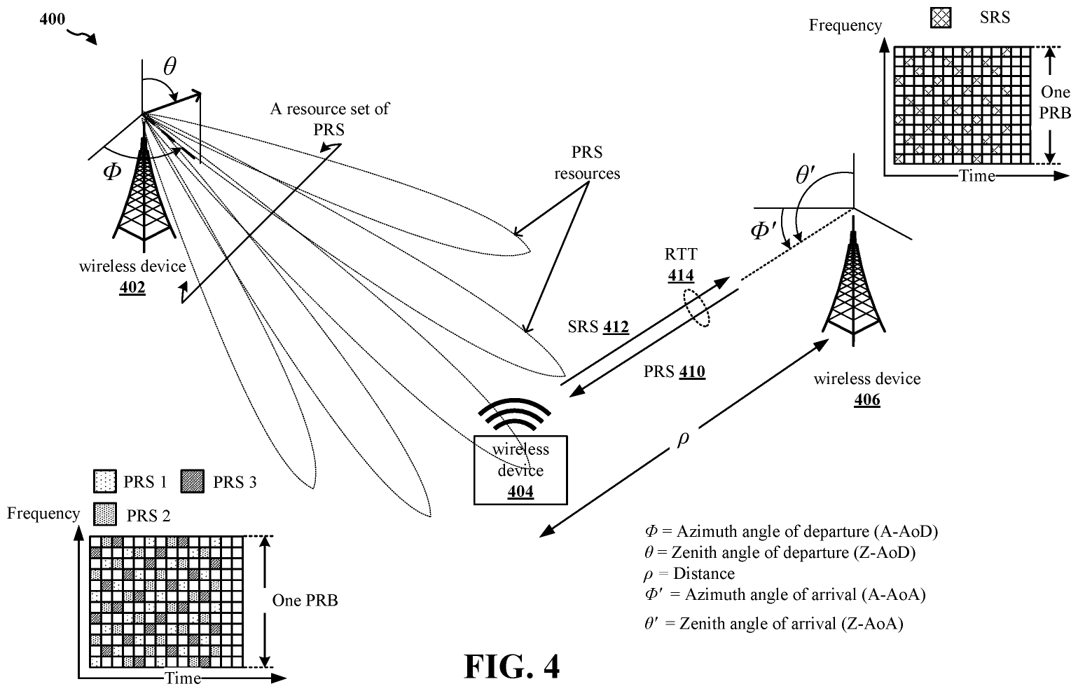

FIG. 4 is a diagram 400 illustrating an example of a positioning based on positioning signal measurements. A positioning signal may be any reference signal which may be measured to calculate a position attribute or a location attribute of a wireless device, for example a positioning reference signal (PRS), a sounding reference signal (SRS), a channel state information (CSI) reference signal (CSI-RS), or a synchronization and signal block (SSB). The wireless device 402 may be a base station, such as a TRP, or a UE with a known position/location, such as a positioning reference unit (PRU) or a UE with a high-accuracy sensor that may identify the location of the UE, for example a GNSS sensor or a GPS sensor. The wireless device 406 may be a base station or a UE with a known position/location. The wireless device 404 may be a UE or a TRP configured to perform positioning to gather data, for example to gather data to train an artificial intelligence machine learning (AI/ML or AIML) model, test positioning signal strength or test positioning noise attributes in an area. The wireless device 404 may transmit UL-SRS 412 at time T_{SRS_TX} and receive DL positioning reference signals (PRS) (DL-PRS) 410 at time T_{PRS_RX}. The wireless device 406 may receive the UL-SRS 412 at time T_{SRS_RX} and transmit the DL-PRS 410 at time T_{PRS_TX}. The wireless device 404 may receive the DL-PRS 410 before transmitting the UL-SRS 412, or may transmit the UL-SRS 412 before receiving the DL-PRS 410. In both cases, a positioning server (e.g., location server(s) 168, LMF 166) or the wireless device 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple wireless devices 402, 406 and measured by the wireless device 404, and the measured TRP Rx-Tx time difference measurements (i.e., |T_{SRS_RX}−T_{PRS_TX}|) and UL-SRS-RSRP at multiple wireless devices 402, 406 of uplink signals transmitted from wireless device 404. The wireless device 404 may measure the UE Rx-Tx time difference measurements (and optionally DL-PRS-RSRP of the received signals) using assistance data received from the positioning server, and the wireless devices 402, 406 may measure the gNB Rx-Tx time difference measurements (and optionally UL-SRS-RSRP of the received signals) using assistance data received from the positioning server. The measurements may be used at the positioning server or the wireless device 404 to determine the RTT. The RTT may be used to estimate the location of the wireless device 404. Other methods are possible for determining the RTT, such as for example using DL-TDOA and/or UL-TDOA measurements.

DL-AoD positioning may make use of the measured DL-PRS-RSRP of downlink signals received from multiple wireless devices 402, 406 at the wireless device 404. The wireless device 404 may measure the DL-PRS-RSRP of the received signals using assistance data received from the positioning server, and the resulting measurements may be used along with the azimuth angle of departure (A-AoD), the zenith angle of departure (Z-AoD), and/or other configuration information to locate the wireless device 404 in relation to the neighboring wireless devices 402, 406.

DL-TDOA positioning may make use of the DL reference signal time difference (RSTD) (and optionally DL-PRS-RSRP) of downlink signals received from multiple wireless devices 402, 406 at the wireless device 404. The wireless device 404 may measure the DL RSTD (and optionally DL-PRS-RSRP) of the received signals using assistance data received from the positioning server, and the resulting measurements may be used along with other configuration information to locate a position/location the wireless device 404 in relation to the neighboring wireless devices 402, 406.

UL-TDOA positioning may make use of the UL relative time of arrival (RTOA) (and optionally UL-SRS-RSRP) at multiple wireless devices 402, 406 of uplink signals transmitted from wireless device 404. The wireless devices 402, 406 may measure the UL-RTOA (and optionally UL-SRS-RSRP) of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices 402, 406 of uplink signals transmitted from the wireless device 404. The wireless devices 402, 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

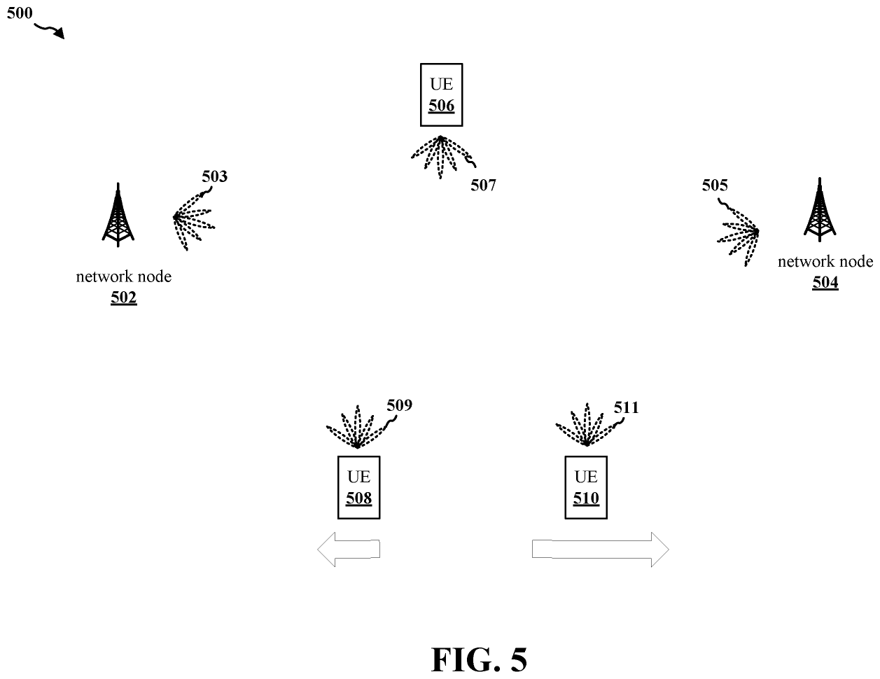

FIG. 5 is a diagram 500 illustrating an example of a plurality of UEs configured to perform an MDT. An MDT may be a technique where a wireless device may perform specific measurements (e.g., reference signal received power (RSRP), reference signal strength indicator (RSSI)) and report specific failures (e.g., radio link failure (RLF), secondary cell group (SCG) failure, random access channel (RACH)) associated with the measurements. In some aspects, a network operator might outfit a vehicle with a wireless device configured to perform such measurements, and may drive the vehicle to different locations within a zone of a base station/TRP to identify locations where wireless signal coverage may be weaker than in other locations. In some aspects, a network may configure a plurality of UEs to perform such specific measurements and report such specific failures. In other words, a network may configure a plurality of UEs, such as the UE 506, the UE 508, and/or the UE 510 to perform one or more MDTs. The network may configure the UEs via a wireless transmission. For example, the network node 502 may transmit an MDT configuration via the set of signals 503, and/or the network node 504 may transmit an MDT configuration via the set of signals 505. The network node 502 may be a base station or a TRP. The network node 504 may be a base station or a TRP. The network may configure a UE to report the results of an MDT with associated parameters and a location calculated via a positioning methodology (e.g., wireless wide area network (WWAN), wireless local area network (WLAN), global navigation satellite system (GNSS), 5G, LTE). For example, the UE 506 may report results of an MDT via the set of signals 507, the UE 508 may report results of an MDT via the set of signals 509, and/or the UE 510 may report results of an MDT via the set of signals 511. The network may correlate the calculated location of the UE with the MDT measurements for better network planning and to tune one or more network configurations to provide improved network coverage and performance.

While the plurality of UEs may be configured to perform MDT and report the results of the MDT, some of the UEs may have different mobility conditions and scenarios than other UEs. For example, the UE 506 may be stationary over a long period of time (e.g., 30 minutes), ensuring that the MDT measurements are properly correlated with the calculated location of the UE 506. In other words, the reported location of the UE 506 may reflect the right/accurate location when the configured event of interest (e.g., RLF, SCG failure, RACH) occurred. In another example, the UE 508 may be traveling at a moderate speed, and the UE 510 may be traveling at a higher speed than the UE 510. When such UEs report MDT measurements, the location fix obtained by initiating the session after the configured event may not accurately reflect the location where the reported event occurred. Such a mismatch between the location fix and the configured event may cause a network to make incorrect decisions, resulting in non-optimal configurations. The UE 510 may take a few tends of seconds to obtain an accurate location fix, which may translate into a significant location error mismatch. While the mismatches for the UE 508 may not cause issues since the UE 508 is traveling at a moderate speed, the mismatches for the UE 510 may result in configurations that cause severe performance degradation, for example a network may incorrectly strengthen transmission power conditions, resulting in power drain, or may incorrectly report a strong signal, resulting in a coverage hole.

In some aspects, a UE may advertise support for MDT. For example, the UE 510 may transmit the set of signals 511 including a UE capability. The UE capability may indicate that the UE 510 is capable of performing MDT. The network node 504 may receive the set of signals 511. The network node 504 may configure an RSRP threshold or an RSSI threshold for the UE 510. The network node 504 may transmit the set of signals 505 including the configured threshold. For example, the set of signals 505 may include an MDT configuration including an indicator of the configured threshold. The UE 510 may receive the configured threshold. The UE 510 may measure pilot signals (e.g., SSB, PRS) from TRPs, for example the set of signals 503 from the network node 502 or the set of signals 505 from the network node 504. If the UE 510 takes a measurement less than or equal to the threshold value (e.g., RSRP<x or RSRP≤x), the UE 510 may periodically perform location fixes more often than it did (e.g., the UE 510 may perform location fixes every 5 seconds instead of every 30 seconds). In some aspects, the network node 504 may configure the periodicity of location fixes in an MDT configuration transmitted as the set of signals 505. In some aspects, the periodicity used may be based on a mobility metric of the UE 510. For example, a periodicity of 30 seconds may be used for a detected speed that is less than or equal to 5 mph (e.g., speed<5 mph or speed≤5 mph), a periodicity of 10 seconds may be used for a detected speed that is between 5 mph and 20 mph (e.g., 5 mph<speed<20 mph, 5 mph≤speed<20 mph, 5 mph<speed≤20 mph, 5 mph≤speed≤20 mph), and a periodicity of 2 seconds may be used for a detected speed that is greater than or equal to 20 mph (e.g., speed>20 mph or speed≥20 mph). In some aspects, the periodicity used may be selected based on the UE capability, for example (a) a class of the UE 510, (b) a power level of the UE 510, (c) a requested accuracy level, (d) a number of Rx chains reported by the UE 510 or (e) a number of Rx antennas used by the UE 510 to measure the calculated location. A lower periodicity increases the likelihood that the UE 510 reports a correct, valid location relative to when the configured event occurred. In some aspects, the MDT configuration may indicate for the UE 510 to report multiple location measurements associated with the measurement parameters (e.g., RSRP, RSSI) associated with each measurement (e.g., multiple location fixes with multiple low RSRP/RSSI values).

In some aspects, the network may configure the UE 510 to autonomously implement an MDT configuration based on an MDT-associated environmental condition of the UE 510. For example, the UE 510 may autonomously implement an MDT configuration based on a sensitivity metric associated with the UE 510 (e.g., class, power level, accuracy level, number of Rx chains reported, number of Rx antennas used for positioning), based on a power head room (PHR) level (UL, DL, or UL/DL), and/or based on a Doppler spread, which may be used as a measure of the mobility of the UE 510. For example, the UE 510 may periodically measure its location every 5 seconds instead of every 30 seconds when the UE 510 calculates an UL PHR that is negative.

In some aspects, the network may configure the UE 510 to report an MDT uncertainty metric that the network may associate with a reported MDT measurement. An MDT uncertainty metric may be, for example, a time between a location calculation and an MDT measurement (indicating an uncertainty of the location of the UE 510 at the time of the MDT measurement since the time of the location calculation), or a calculation based on a mobility metric associated with the UE 510 and the time between the location calculation and the MDT measurement (e.g., the time divided by a maximum period between location calculations). In some aspects, the UE 510 may transmit an RLF report with an IE that indicates the time elapsed when the configured event occurred to the time of the reported/measured location information. The UE 510 may transmit the IE with any MDT report. In some aspects, the UE 510 may calculate a location uncertainty metric based on an environmental condition, for example a mobility metric of the UE 510 (e.g., larger uncertainty metric at higher speeds, lower uncertainty metric at lower speeds). In some aspects, the network may calculate the location uncertainty metric based on reported information from the UE 510, for example a plurality of location fixes and timestamps may be used to calculate a speed of the UE 510, which the network may then use to calculate an uncertainty metric of the UE 510. The network may then associate MDT measurements from the UE 510 with the uncertainty metric. The network may use the uncertainty metric to increase/decrease the relative weights MDT reports.

Based on the reported capability, a network may configure conformance tests for UEs. For example, the network may impose a maximum allowed location uncertainty for a network assisted solution. A UE that transmits a UE capability that the UE can provide improved MDT data (e.g., reported locations at low periodicities or MDT uncertainty metric information) may configure stricter compliance tests (e.g., compliance tests with smaller threshold deviations) to ensure that the UE is compliant with one or more MDT standards, or to ensure that the compliance test configured can be performed by the UE. The network may also provide additional consideration for UEs that provide such compliance reports. For example, in response to receiving a compliance report that a UE submits MDT reports associated with low uncertainty metrics, the network may increase an allocation of an UL resource or a DL resource to the UE. Such consideration may be provided to reward a UE for reporting MDT data, for example during resource allocation or during load balancing. The consideration may provide the UE with additional capability to allow the UE to conditionally report both MDT data without negatively impacting the performance of the UE. In some aspects, such UEs may have improved performance based on an increased allocation of an UL resource or a DL resource to the UE.

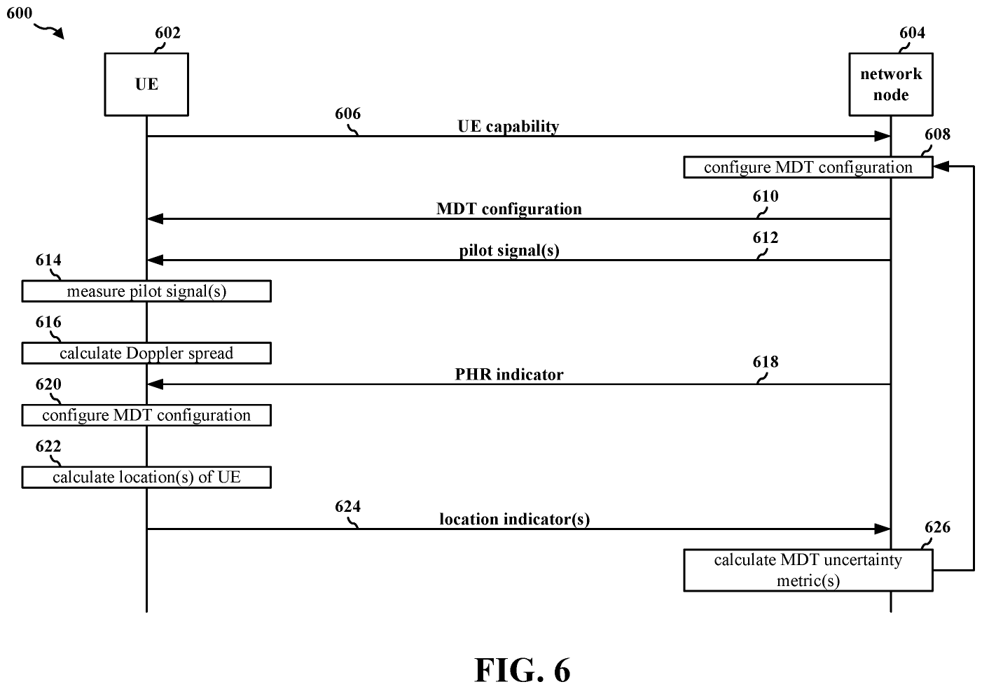

FIG. 6 is a connection flow diagram 600 illustrating an example of location assistance signaling between a UE 602 configured to perform an MDT and a network node 604 that configures the MDT for the UE 602. The UE 602 may transmit a UE capability 606 to the network node 604. The network node 604 may receive the UE capability 606 from the UE 602. The UE capability 606 may include an indicator of a sensitivity metric associated with the UE 602. For example, the sensitivity metric may include at least one of (a) a class of the UE 602, (b) a power level of the UE 602, (c) a requested accuracy level, (d) a number of Rx chains reported by the UE 602 (e.g., reported in an MDT report) or (e) a number of Rx antennas used by the UE 602 to receive the pilot signal. The UE capability 606 may include an indicator of whether the UE 602 is capable of altering a periodicity of when the UE 602 performs location fixes based on an MDT configuration. The UE capability 606 may include an indicator of whether the UE 602 is capable of calculating an MDT uncertainty metric based on an MDT configuration.

At 608, the network node 604 may configure an MDT configuration for the UE 602. The network node 604 may configure the MDT configuration based on the UE capability 606. The network node 604 may configure the MDT configuration based on a standard. The network node 604 may transmit the MDT configuration to the UE 602. The UE 602 may receive the MDT configuration.

The MDT configuration may configure the UE 602 to change a periodicity of its location fixes based on a signal threshold value. For example, the network node 604 may transmit a set of pilot signals 612 to the UE 602. The set of pilot signals 612 may include an SSB or a PRS. At 614, the UE 602 may measure the set of pilot signals 612. The UE 602 may measure a signal strength, or other quality metric for the set of pilot signals. For example, the UE 602 may measure an RSRP or an RSSI of the set of pilot signals 612. In response to the measured value being less than or equal to the signal threshold value of the MDT configuration 610, the UE 602 may change the periodicity of when it performs location fixes.

The MDT configuration may configure the UE 602 to change a periodicity of its location fixes based on a Doppler spread value. For example, the network node 604 may transmit a set of pilot signals 612 to the UE 602. The set of pilot signals 612 may include any suitable reference signal that may be used to measure a Doppler spread. At 616, the UE 602 may calculate a Doppler spread between pilot signals transmitted during two different time domains. The Doppler spread may be used as a mobility metric for the UE 602, for example the Doppler spread may correlate with a speed that the UE 602 is moving. In response to the Doppler spread being greater than or equal to the Doppler spread value of the MDT configuration 610, the UE 602 may change the periodicity of when it performs location fixes.

The MDT configuration may configure the UE 602 to change a periodicity of its location fixes based on a PHR threshold value. For example, the network node 604 may transmit a PHR indicator 618 to the UE 602. The UE 602 may receive the PHR indicator 618 from the network node 604. In some aspects, a negative PHR may be interpreted by the network node 604 to mean that the UE 602 is power limited in uplink (e.g., deep far cell scenario), which may trigger the network node 604 to reduce the periodicity of when the UE 602 performs location fixes. In response to the value of the PHR indicator 618 being less than or equal to a PHR threshold value indicated in the MDT configuration 610, the UE 602 may change the periodicity of when it performs location fixes.

At 620, the UE 602 may configure its MDT based on attributes of the MDT configuration 610. For example, the MDT configuration 610 may indicate a periodicity associated with a sensitivity metric of the UE 602, or the MDT configuration may indicate a PHR threshold value for the UE 602. The UE 602 may autonomously change the periodicity of when it performs location fixes based on the MDT configuration configured at 620. The UE 602 may configure its MDT based upon at least some indicators in the MDT configuration 610 received from the network node 604. For example, the MDT configuration 610 may indicate for the UE 602 to configure its periodicity based on a sensitivity metric of the UE 602, or based on a Doppler spread (measure of mobility) of the UE 602 (e.g., lower periodicity for a higher mobility).

At 622, the UE 602 may calculate its location based on the changed periodicity. The UE 602 may transmit a set of location indicators 624 to the network node 604. The network node 604 may receive the set of location indicators 624. The set of location indicators 624 may include a single calculated location for each time period, or may include a set of calculated locations associated with time periods and/or with MDT reports.

At 626, the network node 604 may calculate an MDT uncertainty metric based on the set of location indicators 624. The network node 604 may use the calculated MDT uncertainty metric to improve the overall performance of MDT by associating each MDT calculated at the UE 702 with a MDT uncertainty metric. For example, MDT calculations performed within two seconds of a location fix may be associated with a higher weight than MDT calculations performed more than two seconds of a location fix. The network node 604 may build conformance tests based on the MDT uncertainty metric to check for validity and/or uncertainty of location information in the MDT reports. The network node 604 may incentivize UEs, such as the UE 602, to report such information, like the set of location indicators 624, to meet location accuracy and uncertainty criteria (e.g., reporting MDT calculations associated with an MDT uncertainty metric less than or equal to a threshold value). The network node 604 may use a conformance test to impose a maximum allowed location uncertainty for utilized MDT calculations (e.g., aggregating MDT reports that meet location accuracy and uncertainty criteria). The network node 604 may allocate additional resource allocation and load balancing to the UE 602 to incentivize the UE 602 to cooperate. For example, for a period of time after receiving the set of location indicators 624, the network node 604 may allocate additional resources to the UE 602, or in response to the network node 604 receiving the UE capability 606 indicating that the UE 602 is capable of transmitting indicators that assist the network node 604 in calculating the set of MDT uncertainty metrics at 626.

In some aspects, the network node 604 may reconfigure the MDT configuration for the UE 602 based on the calculations of the MDT uncertainty metrics at 626. For example, if a calculated MDT uncertainty metric is greater than or equal to a threshold value, the network node 604 may configure the UE 602 to calculate its periodicity for location fixes to be smaller.

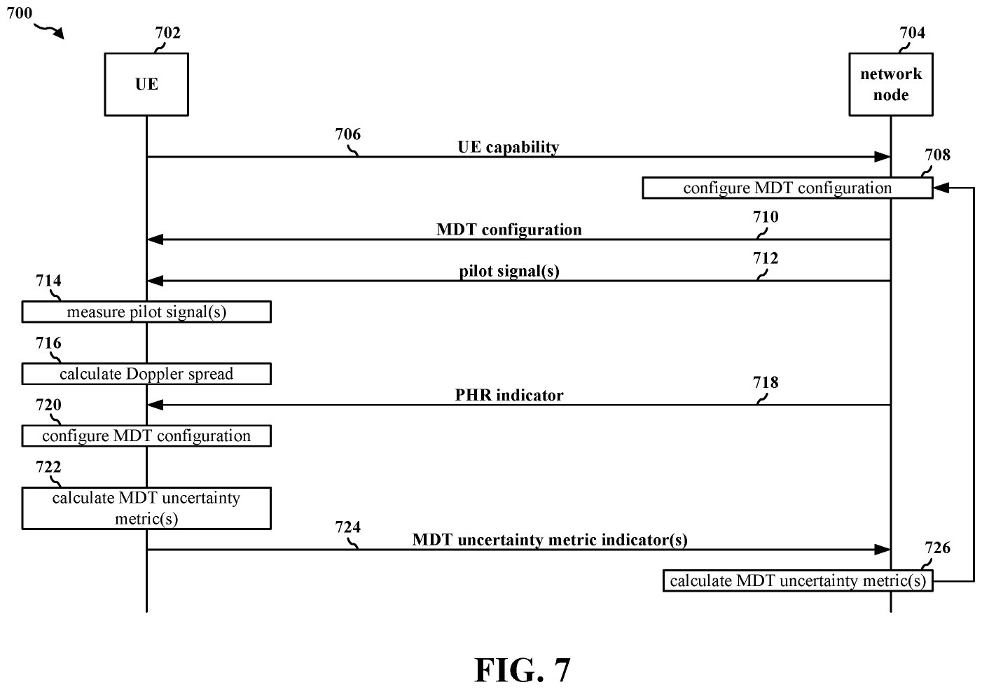

FIG. 7 is a connection flow diagram 700 illustrating an example of location assistance signaling between a UE 702 configured to perform an MDT and a network node 704 that configures the MDT for the UE 702. The UE 702 may transmit a UE capability 706 to the network node 704. The network node 704 may receive the UE capability 706 from the UE 702. The UE capability 706 may include an indicator of a sensitivity metric associated with the UE 702. For example, the sensitivity metric may include at least one of (a) a class of the UE 702, (b) a power level of the UE 702, (c) a requested accuracy level, (d) a number of Rx chains reported by the UE 702 (e.g., reported in an MDT report) or (e) a number of Rx antennas used by the UE 702 to receive the pilot signal. The UE capability 706 may include an indicator of whether the UE 702 is capable of altering a periodicity of when the UE 702 performs location fixes based on an MDT configuration. The UE capability 706 may include an indicator of whether the UE 702 is capable of calculating an MDT uncertainty metric based on an MDT configuration.

At 708, the network node 704 may configure an MDT configuration for the UE 702. The network node 704 may configure the MDT configuration based on the UE capability 706. The network node 704 may configure the MDT configuration based on a standard. The network node 704 may transmit the MDT configuration to the UE 702. The UE 702 may receive the MDT configuration.

The MDT configuration may configure the UE 702 to change a periodicity of its location fixes based on a signal threshold value. For example, the network node 704 may transmit a set of pilot signals 712 to the UE 702. The set of pilot signals 712 may include an SSB or a PRS. At 714, the UE 702 may measure the set of pilot signals 712. For example, the UE 702 may measure an RSRP or an RSSI of the set of pilot signals 712. In response to the measured value being less than or equal to the signal threshold value of the MDT configuration 710, the UE 702 may change the periodicity of when it performs location fixes.

The MDT configuration may configure the UE 702 to change a periodicity of its location fixes based on a Doppler spread value. For example, the network node 704 may transmit a set of pilot signals 712 to the UE 702. The set of pilot signals 712 may include any suitable reference signal that may be used to measure a Doppler spread. At 716, the UE 702 may calculate a Doppler spread between pilot signals transmitted during two different time domains. The Doppler spread may be used as a mobility metric for the UE 702, for example the Doppler spread may correlate with a speed that the UE 702 is moving. In response to the Doppler spread being greater than or equal to the Doppler spread value of the MDT configuration 710, the UE 702 may change the periodicity of when it performs location fixes.

The MDT configuration may configure the UE 702 to change a periodicity of its location fixes based on a PHR threshold value. For example, the network node 704 may transmit a PHR indicator 718 to the UE 702. The UE 702 may receive the PHR indicator 718 from the network node 704. In response to the value of the PHR indicator 718 being less than or equal to a PHR threshold value indicated in the MDT configuration 710, the UE 702 may change the periodicity of when it performs location fixes.

At 720, the UE 702 may configure its MDT based on attributes of the MDT configuration 710. For example, the MDT configuration 710 may indicate a periodicity associated with a sensitivity metric of the UE 702, or the MDT configuration may indicate a PHR threshold value for the UE 702. The UE 702 may autonomously change the periodicity of when it performs location fixes based on the MDT configuration configured at 720.

At 722, the UE 702 may calculate an uncertainty metric based on the MDT configuration 710 and/or the configuration configured at 720. For example, the UE 702 may calculate a time between a location calculation and an MDT measurement or a calculation based on a mobility metric associated with the UE and the time between the location calculation and the MDT measurement.

The UE 702 may transmit a set of MDT uncertainty metric indicators 724 to the network node 704. The network node 704 may receive the set of MDT uncertainty metric indicators 724 from the UE 702.

At 726, the network node 704 may calculate an MDT uncertainty metric based on the set of MDT uncertainty metric indicators 724. For example, the network node 704 may calculate an MDT uncertainty metric based on a time between when a location was calculated at the UE 702 and when an MDT measurement took place at the UE 702.

The network node 704 may use the calculated MDT uncertainty metric to improve the overall performance of MDT by associating each MDT calculated at the UE 702 with a MDT uncertainty metric. For example, MDT calculations performed within two seconds of a location fix may be associated with a higher weight than MDT calculations performed more than two seconds of a location fix. The network node 704 may build conformance tests based on the MDT uncertainty metric to check for validity and/or uncertainty of location information in the MDT reports. The network node 704 may incentivize UEs, such as the UE 702, to report such information, like the set of MDT uncertainty metric indicators 724, to meet location accuracy and uncertainty criteria (e.g., reporting MDT calculations associated with an MDT uncertainty metric less than or equal to a threshold value). The network node 704 may use a conformance test to impose a maximum allowed location uncertainty for utilized MDT calculations (e.g., aggregating MDT reports that meet location accuracy and uncertainty criteria). The network node 704 may allocate additional resource allocation and load balancing to the UE 702 to incentivize the UE 702 to cooperate. For example, for a period of time after receiving the set of MDT uncertainty metric indicators 724, the network node 704 may allocate additional resources to the UE 702, or in response to the network node 704 receiving the UE capability 706 indicating that the UE 702 is capable of transmitting indicators that assist the network node 704 in calculating the set of MDT uncertainty metrics at 726.

In some aspects, the network node 704 may reconfigure the MDT configuration for the UE 702 based on the calculations of the MDT uncertainty metrics at 726. For example, if a calculated MDT uncertainty metric is greater than or equal to a threshold value, the network node 704 may configure the UE 702 to calculate its periodicity for location fixes to be smaller.

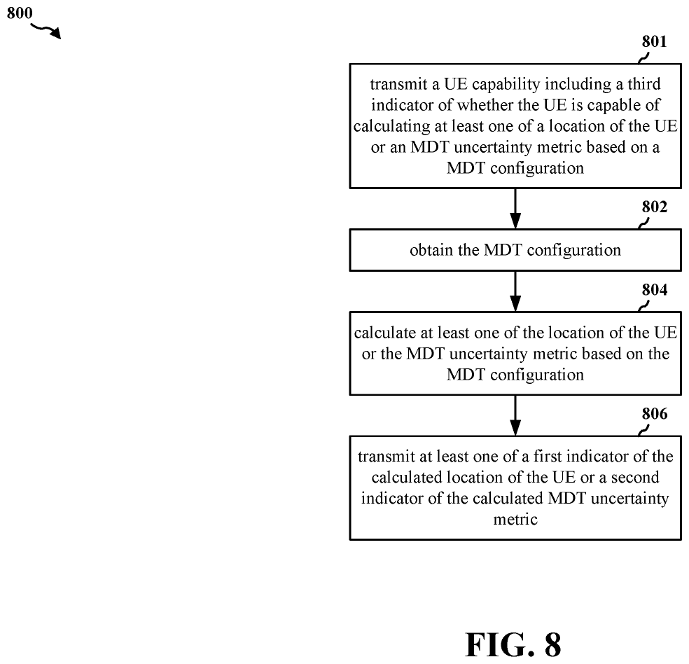

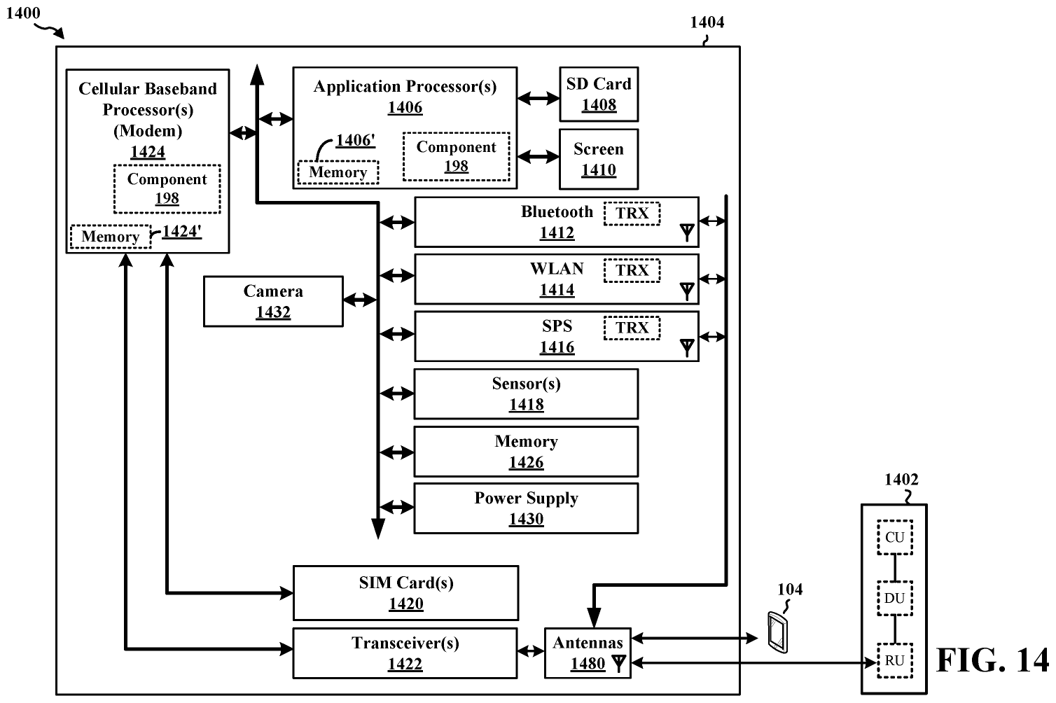

FIG. 8 is a flowchart 800 of a method of wireless communication. The method may be performed by a UE (e.g., the UE 104, the UE 350; the wireless device 402, the wireless device 404, the wireless device 406, the UE 506, the UE 508, the UE 510, the UE 702; the apparatus 1404). At 801, the UE may transmit a UE capability including a third indicator of whether the UE is capable of calculating at least one of a location of the UE or an MDT uncertainty metric based on a MDT configuration. For example, 801 may be performed by the UE 702 in FIG. 7, which may transmit a UE capability 706 including a third indicator of whether the UE 702 is capable of calculating at least one of a location of the UE or an MDT uncertainty metric based on a MDT configuration. Moreover, 801 may be performed by the component 198 in FIG. 3 or 14.

At 802, the UE may obtain the MDT configuration. For example, 802 may be performed by the UE 702 in FIG. 7, which may receive the MDT configuration 710 from the network node 704. In another example, the UE 702 may configure an MDT configuration at 720. Moreover, 802 may be performed by the component 198 in FIG. 3 or 14.

At 804, the UE may calculate at least one of the location of the UE or the MDT uncertainty metric based on the MDT configuration. For example, 804 may be performed by the UE 702 in FIG. 7, which may, at 722, calculate a set of uncertainty metrics associated with the UE 702 based on the MDT configuration obtained at 802. In another example, 804 may be performed by the UE 602 in FIG. 6, which may, at 622, calculate a location of the UE 602 based on the MDT configuration obtained at 802. Moreover, 804 may be performed by the component 198 in FIG. 3 or 14.

At 806, the UE may transmit at least one of a first indicator of the calculated location of the UE or a second indicator of the calculated MDT uncertainty metric. For example, 806 may be performed by the UE 702 in FIG. 7, which may transmit the set of MDT uncertainty metric indicators 724 to the network node 704. In another example, 806 may be performed by the UE 602 in FIG. 6, which may transmit a set of location indicators 624 to the network node 604. Moreover, 806 may be performed by the component 198 in FIG. 3 or 14.

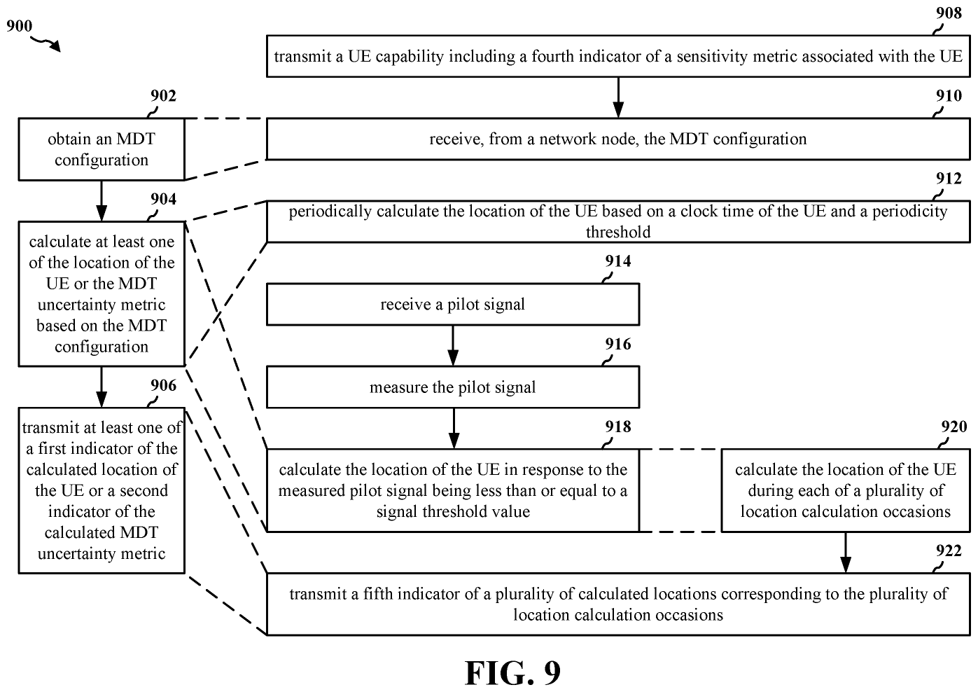

FIG. 9 is a flowchart 900 of a method of wireless communication. The method may be performed by a UE (e.g., the UE 104, the UE 350; the wireless device 402, the wireless device 404, the wireless device 406, the UE 506, the UE 508, the UE 510, the UE 702; the apparatus 1404). At 902, the UE may obtain the MDT configuration. For example, 902 may be performed by the UE 702 in FIG. 7, which may receive the MDT configuration 710 from the network node 704. In another example, the UE 702 may configure an MDT configuration at 720. Moreover, 902 may be performed by the component 198 in FIG. 3 or 14.

At 904, the UE may calculate at least one of the location of the UE or the MDT uncertainty metric based on the MDT configuration. For example, 904 may be performed by the UE 702 in FIG. 7, which may, at 722, calculate a set of uncertainty metrics associated with the UE 702 based on the MDT configuration obtained at 902. In another example, 904 may be performed by the UE 602 in FIG. 6, which may, at 622, calculate a location of the UE 602 based on the MDT configuration obtained at 902. Moreover, 904 may be performed by the component 198 in FIG. 3 or 14.

At 906, the UE may transmit at least one of a first indicator of the calculated location of the UE or a second indicator of the calculated MDT uncertainty metric. For example, 906 may be performed by the UE 702 in FIG. 7, which may transmit the set of MDT uncertainty metric indicators 724 to the network node 704. In another example, 906 may be performed by the UE 602 in FIG. 6, which may transmit a set of location indicators 624 to the network node 604. Moreover, 906 may be performed by the component 198 in FIG. 3 or 14.

At 908, the UE may transmit a UE capability including a fourth indicator of a sensitivity metric associated with the UE. For example, 908 may be performed by the UE 702 in FIG. 7, which may transmit the UE capability 706 to the network node 704. The UE capability 706 may include an indicator of a sensitivity metric associated with the UE 702. Moreover, 908 may be performed by the component 198 in FIG. 3 or 14.

At 910, the UE may obtain an MDT configuration by receiving, from a network node, the MDT configuration. For example, 910 may be performed by the UE 702 in FIG. 7, which may receive, from the network node 704, the MDT configuration 710. Moreover, 910 may be performed by the component 198 in FIG. 3 or 14.

At 912, the UE may calculate at least one of the location of the UE or the MDT uncertainty metric based on the MDT configuration by periodically calculating the location of the UE based on a clock time of the UE and a periodicity threshold. For example, 912 may be performed by the UE 602 in FIG. 6, which may, at 622, periodically calculate the location of the UE 602 based on a clock time of the UE 602 and a periodicity threshold. The periodicity threshold may be indicated by the MDT configuration 610 or the configuration configured at 620 by the UE 602. Moreover, 912 may be performed by the component 198 in FIG. 3 or 14.

At 914, the UE may receive a pilot signal. For example, 914 may be performed by the UE 702 in FIG. 7, which may receive the set of pilot signals 612 from the network node 604. The UE 702 may also receive pilot signals from other wireless devices. Moreover, 914 may be performed by the component 198 in FIG. 3 or 14.

At 916, the UE may measure the pilot signal. For example, 916 may be performed by the UE 702 in FIG. 7, which may, at 614, measure the set of pilot signals 612. Moreover, 916 may be performed by the component 198 in FIG. 3 or 14.

At 918, the UE may calculate at least one of the location of the UE or the MDT uncertainty metric based on the MDT configuration by calculating the location of the UE in response to the measured pilot signal being less than or equal to a signal threshold value. For example, 918 may be performed by the UE 602 in FIG. 6, which may, at 622, calculate the location of the UE 602 in response to the measured pilot signal being less than or equal to a signal threshold value (e.g., a low RSRP). Moreover, 918 may be performed by the component 198 in FIG. 3 or 14.

At 920, the UE may calculate the location of the UE in response to the measured pilot signal being less than or equal to a signal threshold value by calculating the location of the UE during each of a plurality of location calculation occasions. For example, 920 may be performed by the UE 602 in FIG. 6, which may, at 622, calculate the location of the UE 602 during each of a plurality of location calculation occasions. Moreover, 920 may be performed by the component 198 in FIG. 3 or 14.

At 922, the UE may transmit the calculated location of the UE by transmitting a fifth indicator of a plurality of calculated locations corresponding to the plurality of location calculation occasions. For example, 922 may be performed by the UE 702 in FIG. 7, which may transmit the set of location indicators 624 to the network node 604. The set of location indicators 624 may include an indicator of a plurality of calculated locations corresponding to the plurality of location calculation occasions. Moreover, 922 may be performed by the component 198 in FIG. 3 or 14.

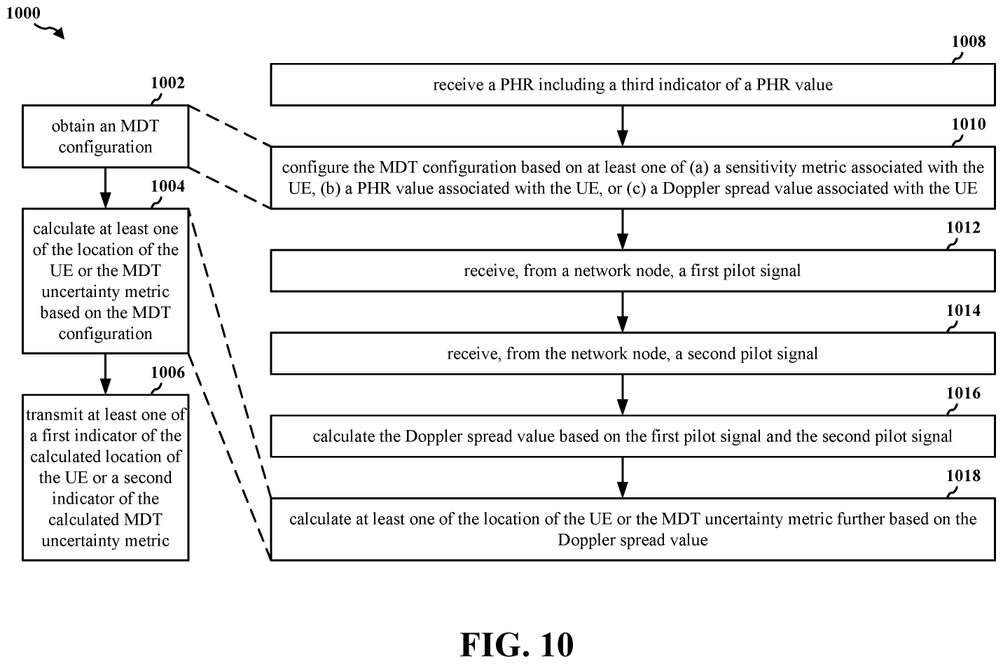

FIG. 10 is a flowchart 1000 of a method of wireless communication. The method may be performed by a UE (e.g., the UE 104, the UE 350; the wireless device 402, the wireless device 404, the wireless device 406, the UE 506, the UE 508, the UE 510, the UE 702; the apparatus 1404). At 1002, the UE may obtain the MDT configuration.

For example, 1002 may be performed by the UE 702 in FIG. 7, which may receive the MDT configuration 710 from the network node 704. In another example, the UE 702 may configure an MDT configuration at 720. Moreover, 1002 may be performed by the component 198 in FIG. 3 or 14.

At 1004, the UE may calculate at least one of the location of the UE or the MDT uncertainty metric based on the MDT configuration. For example, 1004 may be performed by the UE 702 in FIG. 7, which may, at 722, calculate a set of uncertainty metrics associated with the UE 702 based on the MDT configuration obtained at 1002. In another example, 1004 may be performed by the UE 602 in FIG. 6, which may, at 622, calculate a location of the UE 602 based on the MDT configuration obtained at 1002. Moreover, 1004 may be performed by the component 198 in FIG. 3 or 14.

At 1006, the UE may transmit at least one of a first indicator of the calculated location of the UE or a second indicator of the calculated MDT uncertainty metric. For example, 1006 may be performed by the UE 702 in FIG. 7, which may transmit the set of MDT uncertainty metric indicators 724 to the network node 704. In another example, 1006 may be performed by the UE 602 in FIG. 6, which may transmit a set of location indicators 624 to the network node 604. Moreover, 1006 may be performed by the component 198 in FIG. 3 or 14.

At 1008, the UE may receive a PHR including a third indicator of a PHR value. For example, 1008 may be performed by the UE 702 in FIG. 7, which may receive the PHR indicator 718 from the network node 704. The indicator may include an indicator of a PHR value. Moreover, 1008 may be performed by the component 198 in FIG. 3 or 14.

At 1010, the UE may obtain an MDT configuration by configuring the MDT configuration based on at least one of (a) a sensitivity metric associated with the UE, (b) a PHR value associated with the UE, or (c) a Doppler spread value associated with the UE. For example, 1010 may be performed by the UE 702 in FIG. 7, which may, at 720, configure the MDT configuration based on at least one of (a) a sensitivity metric associated with the UE 702 (e.g., the Rx sensitivity of the UE 702), (b) a PHR value associated with the UE 702 (e.g., from the PHR indicator 718), or (c) a Doppler spread value associated with the UE 702 (e.g., estimated by the UE 702). Moreover, 1010 may be performed by the component 198 in FIG. 3 or 14.

At 1012, the UE may receive, from a network node, a first pilot signal. For example, 1012 may be performed by the UE 702 in FIG. 7, which may receive, from the network node 704, the set of pilot signals 712, which may include a first pilot signal. Moreover, 1012 may be performed by the component 198 in FIG. 3 or 14.

At 1014, the UE may receive, from the network node, a second pilot signal. For example, 1014 may be performed by the UE 702 in FIG. 7, which may receive, from the network node 704, the set of pilot signals 712, which may include a second pilot signal. Moreover, 1014 may be performed by the component 198 in FIG. 3 or 14.

At 1016, the UE may calculate the Doppler spread value based on the first pilot signal and the second pilot signal. For example, 1016 may be performed by the UE 702 in FIG. 7, which may, at 716, calculate the Doppler spread value based on the first pilot signal and the second pilot signal. Moreover, 1016 may be performed by the component 198 in FIG. 3 or 14.

At 1018, the UE may calculate at least one of the location of the UE or the MDT uncertainty metric based on the MDT configuration by calculating at least one of the location of the UE or the MDT uncertainty metric further based on the Doppler spread value. For example, 1018 may be performed by the UE 602 in FIG. 6, which may, at 622, calculate the location of the UE further based on the Doppler spread value calculated at 1016. In another example, 1018 may be performed by the UE 702 in FIG. 7, which may, at 722, calculate the MDT uncertainty metric further based on the Doppler spread value calculated at 1016. Moreover, 1018 may be performed by the component 198 in FIG. 3 or 14.

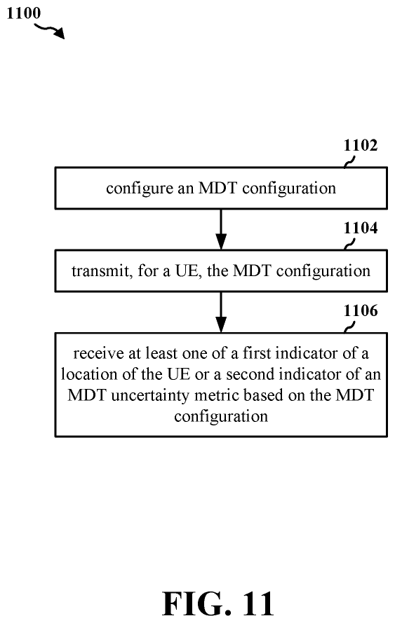

FIG. 11 is a flowchart 1100 of a method of wireless communication. The method may be performed by a network node (e.g., the base station 102, the base station 310; the wireless device 402, the wireless device 404, the wireless device 406; the network node 502, the network node 504, the network node 704; the network entity 1402, the network entity 1502, the network entity 1660). At 1102, the network node may configure an MDT configuration. For example, 1102 may be performed by the network node 704 in FIG. 7, which may, at 708, configure an MDT configuration. Moreover, 1102 may be performed by the component 199 in FIG. 3, 15, or 16.

At 1104, the network node may transmit, for a UE, the MDT configuration. For example, 1104 may be performed by the network node 704 in FIG. 7, which may transmit, for the UE 702, the MDT configuration 710. Moreover, 1104 may be performed by the component 199 in FIG. 3, 15, or 16.

At 1106, the network node may receive at least one of a first indicator of a location of the UE or a second indicator of an MDT uncertainty metric based on the MDT configuration. For example, 1106 may be performed by the network node 704 in FIG. 7, which may receive the set of MDT uncertainty metric indicators 724 from the UE 702. In another example, 1106 may be performed by the network node 604 in FIG. 6, which may receive the set of location indicators 624 from the UE 602. Moreover, 1106 may be performed by the component 199 in FIG. 3, 15, or 16.

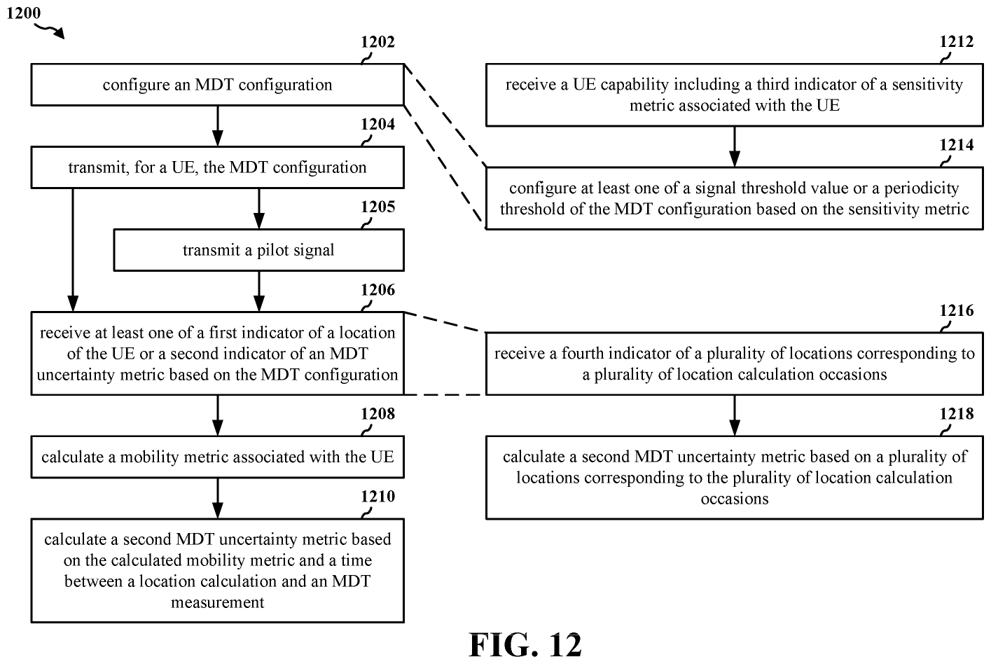

FIG. 12 is a flowchart 1200 of a method of wireless communication. The method may be performed by a network node (e.g., the base station 102, the base station 310; the wireless device 402, the wireless device 404, the wireless device 406; the network node 502, the network node 504, the network node 704; the network entity 1402, the network entity 1502, the network entity 1660). At 1202, the network node may configure an MDT configuration. For example, 1202 may be performed by the network node 704 in FIG. 7, which may, at 708, configure an MDT configuration. Moreover, 1202 may be performed by the component 199 in FIG. 3, 15, or 16.

At 1204, the network node may transmit, for a UE, the MDT configuration. For example, 1204 may be performed by the network node 704 in FIG. 7, which may transmit, for the UE 702, the MDT configuration 710. Moreover, 1204 may be performed by the component 199 in FIG. 3, 15, or 16.

At 1205, the network node may transmit a pilot signal. For example, 1204 may be performed by the network node 704 in FIG. 7, which may transmit the set of pilot signals 712 at the UE 702. Moreover, 1204 may be performed by the component 199 in FIG. 3, 15, or 16.

At 1206, the network node may receive at least one of a first indicator of a location of the UE or a second indicator of an MDT uncertainty metric based on the MDT configuration. For example, 1206 may be performed by the network node 704 in FIG. 7, which may receive the set of MDT uncertainty metric indicators from the UE 702. In another example, 1206 may be performed by the network node 604 in FIG. 6, which may receive the set of location indicators 624 from the UE 602. Moreover, 1206 may be performed by the component 199 in FIG. 3, 15, or 16.

At 1208, the network node may calculate a mobility metric associated with the UE. For example, 1208 may be performed by the network node 704 in FIG. 7, which may, at 716, calculate a mobility metric associated with the UE 702, such as a Doppler spread of the UE 702 or a speed of the UE 702. Moreover, 1208 may be performed by the component 199 in FIG. 3, 15, or 16.

At 1210, the network node may calculate a second MDT uncertainty metric based on the calculated mobility metric and a time between a location calculation and an MDT measurement. For example, 1210 may be performed by the network node 704 in FIG. 7, which may, at 722, calculate a second MDT uncertainty metric based on the calculated mobility metric and a time between a location calculation and an MDT measurement. Moreover, 1210 may be performed by the component 199 in FIG. 3, 15, or 16.

At 1212, the network node may receive a UE capability including a third indicator of a sensitivity metric associated with the UE. For example, 1212 may be performed by the network node 704 in FIG. 7, which may receive the UE capability 706 from the UE 702. The UE capability 706 may include an indicator of a sensitivity metric associated with the UE 702 (e.g., a model of the UE 702, an Rx capability of the UE 702). Moreover, 1212 may be performed by the component 199 in FIG. 3, 15, or 16.

At 1214, the network node may configure the MDT configuration by configuring at least one of a signal threshold value or a periodicity threshold of the MDT configuration based on the sensitivity metric. For example, 1214 may be performed by the network node 704 in FIG. 7, which may, at 708, configure at least one of a signal threshold value or a periodicity threshold of the MDT configuration 710 based on the sensitivity metric indicated by the UE capability 706. Moreover, 1214 may be performed by the component 199 in FIG. 3, 15, or 16.

At 1216, the network node may receive at least one of the location of the UE by receiving a fourth indicator of a plurality of locations corresponding to a plurality of location calculation occasions. For example, 1216 may be performed by the network node 604 in FIG. 6, which may receive a set of location indicators 624 from the UE 602. The set of location indicators 624 may include an indicator of a plurality of locations corresponding to a plurality of location calculation occasions. Moreover, 1216 may be performed by the component 199 in FIG. 3, 15, or 16.

At 1218, the network node may calculate a second MDT uncertainty metric based on a plurality of locations corresponding to the plurality of location calculation occasions. For example, 1218 may be performed by the network node 604 in FIG. 6, which may, at 626, calculate an MDT uncertainty metric based on a plurality of locations corresponding to the plurality of location calculation occasions. Moreover, 1218 may be performed by the component 199 in FIG. 3, 15, or 16.

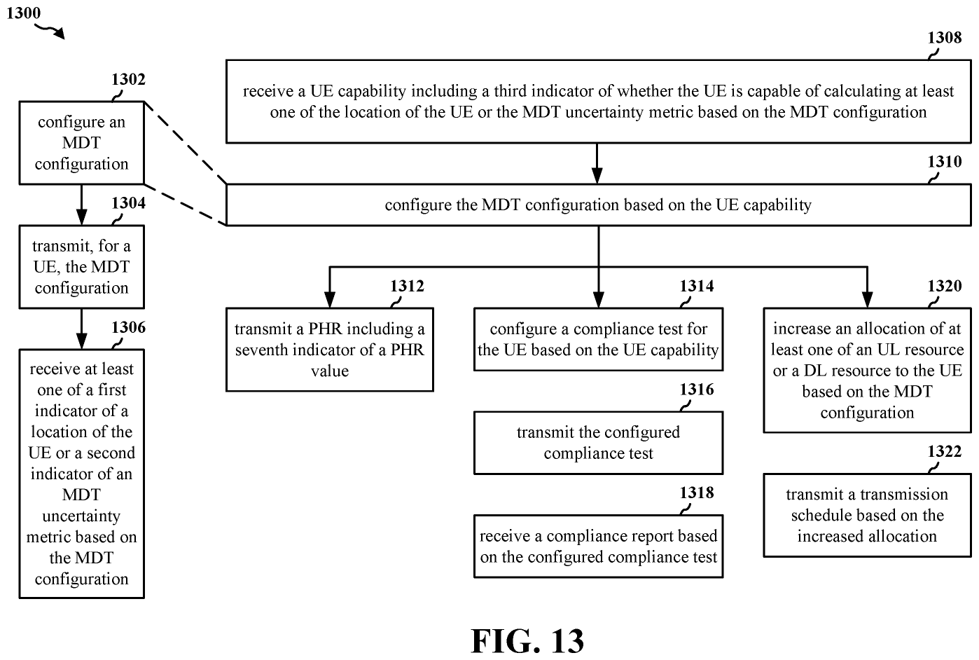

FIG. 13 is a flowchart 1300 of a method of wireless communication. The method may be performed by a network node (e.g., the base station 102, the base station 310; the wireless device 402, the wireless device 404, the wireless device 406; the network node 502, the network node 504, the network node 704; the network entity 1402, the network entity 1502, the network entity 1660). At 1302, the network node may configure an MDT configuration. For example, 1302 may be performed by the network node 704 in FIG. 7, which may, at 708, configure an MDT configuration. Moreover, 1302 may be performed by the component 199 in FIG. 3, 15, or 16.

At 1304, the network node may transmit, for a UE, the MDT configuration. For example, 1304 may be performed by the network node 704 in FIG. 7, which may transmit, for the UE 702, the MDT configuration 710. Moreover, 1304 may be performed by the component 199 in FIG. 3, 15, or 16.

At 1306, the network node may receive at least one of a first indicator of a location of the UE or a second indicator of an MDT uncertainty metric based on the MDT configuration. For example, 1306 may be performed by the network node 704 in FIG. 7, which may receive the set of MDT uncertainty metric indicators from the UE 702. In another example, 1306 may be performed by the network node 604 in FIG. 6, which may receive the set of location indicators 624 from the UE 602. Moreover, 1306 may be performed by the component 199 in FIG. 3, 15, or 16.

At 1308, the network node may receive a UE capability including a third indicator of whether the UE is capable of calculating at least one of the location of the UE or the MDT uncertainty metric based on the MDT configuration. For example, 1308 may be performed by the network node 704 in FIG. 7, which may receive the UE capability 706 from the UE 702. The UE capability 706 may include an indicator of whether the UE 702 is capable of calculating the location of the UE 702 and/or an MDT uncertainty metric based on an MDT configuration. Moreover, 1308 may be performed by the component 199 in FIG. 3, 15, or 16.

At 1310, the network node may configure the MDT configuration by configuring the MDT configuration based on the UE capability. For example, 1310 may be performed by the network node 704 in FIG. 7, which may, at 708, configure the MDT configuration 710 based on the UE capability 706. Moreover, 1310 may be performed by the component 199 in FIG. 3, 15, or 16.

At 1312, the network node may transmit a PHR including a seventh indicator of a PHR value. For example, 1312 may be performed by the network node 704 in FIG. 7, which may transmit the PHR indicator 618 to the UE 702. The PHR indicator 618 may include an indicator of a PHR value. Moreover, 1312 may be performed by the component 199 in FIG. 3, 15, or 16.

At 1314, the network node may configure a compliance test for the UE based on the UE capability. For example, 1314 may be performed by the network node 704 in FIG. 7, which may configure a compliance test for the UE 702 based on the UE capability 606. For example, the compliance test may be based on a class of the UE 702. Moreover, 1314 may be performed by the component 199 in FIG. 3, 15, or 16.

At 1316, the network node may transmit the configured compliance test. For example, 1316 may be performed by the network node 704 in FIG. 7, which may transmit the configured compliance test to the UE 702. Moreover, 1316 may be performed by the component 199 in FIG. 3, 15, or 16.

At 1318, the network node may receive a compliance report based on the configured compliance test. For example, 1318 may be performed by the network node 704 in FIG. 7, which may receive a compliance report from the UE 702 based on the configured compliance test. Moreover, 1318 may be performed by the component 199 in FIG. 3, 15, or 16.

At 1320, the network node may increase an allocation of at least one of an UL resource or a DL resource to the UE based on the MDT configuration. For example, 1320 may be performed by the network node 704 in FIG. 7, which may increase an allocation of at least one of an UL resource or a DL resource to the UE 702 based on the MDT configuration and/or the results of the compliance test indicated in the compliance report. Moreover, 1320 may be performed by the component 199 in FIG. 3, 15, or 16.

At 1322, the network node may transmit a transmission schedule based on the increased allocation. For example, 1322 may be performed by the network node 704 in FIG. 7, which may transmit a transmission schedule to the UE 702 based on the increased allocation. Moreover, 1322 may be performed by the component 199 in FIG. 3, 15, or 16.

FIG. 14 is a diagram 1400 illustrating an example of a hardware implementation for an apparatus 1404. The apparatus 1404 may be a UE, a component of a UE, or may implement UE functionality. In some aspects, the apparatus 904 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to obtain an MDT configuration. The component 198 may be configured to calculate at least one of a location of the apparatus 1404 or an MDT uncertainty metric based on the MDT configuration. The component 198 may be configured to transmit at least one of a first indicator of the calculated location of the apparatus 1404 or a second indicator of the calculated MDT uncertainty metric. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for obtaining an MDT configuration. The apparatus 1404 may include means for calculating at least one of a location of the apparatus 1404 or an MDT uncertainty metric based on the MDT configuration. The apparatus 1404 may include means for transmitting at least one of a first indicator of the calculated location of the apparatus 1404 or a second indicator of the calculated MDT uncertainty metric. The apparatus 1404 may include means for obtaining the MDT configuration by receiving, from a network node, the MDT configuration. The MDT configuration may include a third indicator of a signal threshold value. The apparatus 1404 may include means for calculating at least one of the location of the apparatus 1404 or the MDT uncertainty metric based on the MDT configuration by (a) receiving a pilot signal, (b) measuring the pilot signal, and (c) calculating the location of the apparatus 1404 in response to the measured pilot signal being less than or equal to the signal threshold value. The signal threshold value may include at least one of: an RSRP threshold value; or an RSSI threshold value. The pilot signal may include at least one of an SSB or a PRS. The MDT configuration may include a fourth indicator of a plurality of location calculation occasions. The apparatus 1404 may include means for calculating the location of the apparatus 1404 by calculating the location of the apparatus 1404 during each of the plurality of location calculation occasions. The apparatus 1404 may include means for transmitting the first indicator of the calculated location of the apparatus 1404 by transmitting a fifth indicator of a plurality of calculated locations corresponding to the plurality of location calculation occasions. The plurality of calculated locations may include the calculated location of the apparatus 1404. The apparatus 1404 may include means for transmitting a UE capability including a fourth indicator of a sensitivity metric associated with the apparatus 1404 before the reception of the MDT configuration. The sensitivity metric may include at least one of (a) a class of the apparatus 1404, (b) a power level of the apparatus 1404, (c) a requested accuracy level, (d) a number of Rx chains reported by the apparatus 1404, or a number of Rx antennas used by the apparatus 1404 to receive the pilot signal. The MDT configuration may include a third indicator of a periodicity threshold. The apparatus 1404 may include means for calculating at least one of the location of the apparatus 1404 or the MDT uncertainty metric based on the MDT configuration by periodically calculating the location of the apparatus 1404 based on a clock time of the apparatus 1404 and the periodicity threshold. The apparatus 1404 may include means for obtaining the MDT configuration by configuring the MDT configuration based on at least one of (a) a sensitivity metric associated with the apparatus 1404, (b) a PHR value associated with the apparatus 1404, or (c) a Doppler spread value associated with the apparatus 1404. The sensitivity metric may include at least one of (a) a class of the apparatus 1404, (b) a power level of the apparatus 1404, (c) a requested accuracy level, (d) a number of Rx chains reported by the apparatus 1404, or (e) a number of Rx antennas used by the apparatus 1404 to measure the calculated location. The apparatus 1404 may include means for receiving a PHR including a third indicator of the PHR value before the configuration of the MDT configuration. The apparatus 1404 may include means for receiving, from a network node, a first pilot signal. The apparatus 1404 may include means for receiving, from the network node, a second pilot signal. The apparatus 1404 may include means for calculating the Doppler spread value based on the first pilot signal and the second pilot signal. The MDT uncertainty metric may include at least one of a time between a location calculation and an MDT measurement or a calculation based on a mobility metric associated with the apparatus 1404 and the time between the location calculation and the MDT measurement. The apparatus 1404 may include means for transmitting, before the obtainment of the MDT configuration, a UE capability including a third indicator of whether the apparatus 1404 is capable of calculating at least one of the location of the apparatus 1404 or the MDT uncertainty metric based on the MDT configuration. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

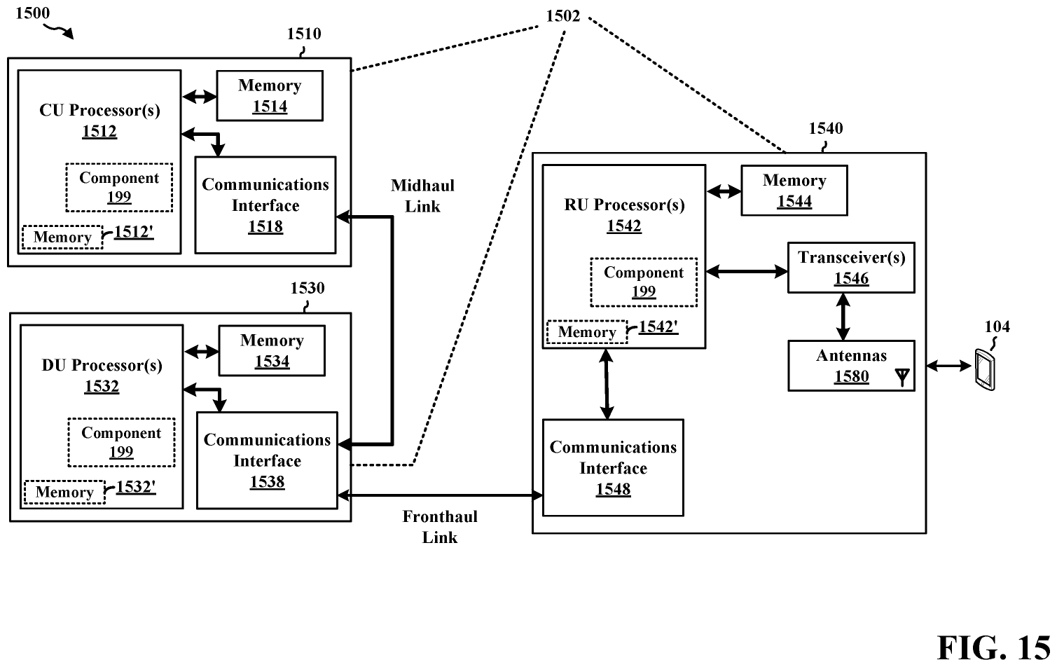

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure an MDT configuration. The component 199 may be configured to transmit, for the UE 104, the MDT configuration. The component 199 may be configured to receive at least one of a first indicator of a location of the UE 104 or a second indicator of an MDT uncertainty metric based on the MDT configuration. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for configuring an MDT configuration. The network entity 1602 may include means for transmitting, for a UE, the MDT configuration. The network entity 1602 may include means for receiving at least one of a first indicator of a location of the UE or a second indicator of an MDT uncertainty metric based on the MDT configuration. The MDT configuration may include a signal threshold value. The network entity 1602 may include means for transmitting a pilot signal. The reception of the at least one of the first indicator or the second indicator may be based on the pilot signal and the signal threshold value. The signal threshold value may include at least one of an RSRP threshold value; or an RSSI threshold value. The pilot signal may include at least one of an SSB or a PRS. The network entity 1602 may include means for receiving a UE capability including a third indicator of a sensitivity metric associated with the UE. The network entity 1602 may include means for configuring the MDT configuration by configuring at least one of the signal threshold value or a periodicity threshold of the MDT configuration based on the sensitivity metric. The sensitivity metric may include at least one of (a) a class of the UE, (b) a power level of the UE, (c) a requested accuracy level, (d) a number of Rx chains reported by the UE or (e) a number of Rx antennas used by the UE to receive the pilot signal. The MDT configuration may include a third indicator of a plurality of location calculation occasions. The network entity 1602 may include means for receiving the first indicator of the location of the UE by receiving a fourth indicator of a plurality of locations corresponding to the plurality of location calculation occasions. The plurality of locations may include the location of the UE. The network entity 1602 may include means for calculating a second MDT uncertainty metric based on the plurality of locations corresponding to the plurality of location calculation occasions. The MDT uncertainty metric may include at least one of a time between a location calculation and an MDT measurement or a calculation based on a mobility metric associated with the UE and the time between the location calculation and the MDT measurement. The network entity 1602 may include means for calculating the mobility metric associated with the UE. The network entity 1602 may include means for calculating a second MDT uncertainty metric based on the calculated mobility metric and the time between the location calculation and the MDT measurement. The network entity 1602 may include means for receiving a UE capability including a third indicator of whether the UE is capable of calculating at least one of the location of the UE or the MDT uncertainty metric based on the MDT configuration. The network entity 1602 may include means for configuring the MDT configuration by configuring the MDT configuration based on the UE capability. The MDT configuration may include at least one of (a) a fourth indicator for the UE to configure at least one of a signal threshold value or a periodicity threshold based on a sensitivity metric associated with the UE, (b) a fifth indicator of the UE to configure at least one of the signal threshold value or the periodicity threshold based on a PHR value associated with the UE, (c) or a sixth indicator of the UE to configure at least one of the signal threshold value or the periodicity threshold based on a Doppler spread value associated with the UE. The sensitivity metric may include at least one of (a) a class of the UE, (b) a power level of the UE, (c) a requested accuracy level, (d) a number of Rx chains reported by the UE or (e) a number of Rx antennas used by the UE to measure the calculated location. The network entity 1602 may include means for transmitting a PHR including a seventh indicator of the PHR value. The network entity 1602 may include means for configuring a compliance test for the UE based on the UE capability. The network entity 1602 may include means for transmitting the configured compliance test. The network entity 1602 may include means for receiving a compliance report based on the configured compliance test. The network entity 1602 may include means for increasing an allocation of at least one of an UL resource or a DL resource to the UE based on the MDT configuration. The network entity 1602 may include means for transmitting a transmission schedule based on the increased allocation. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

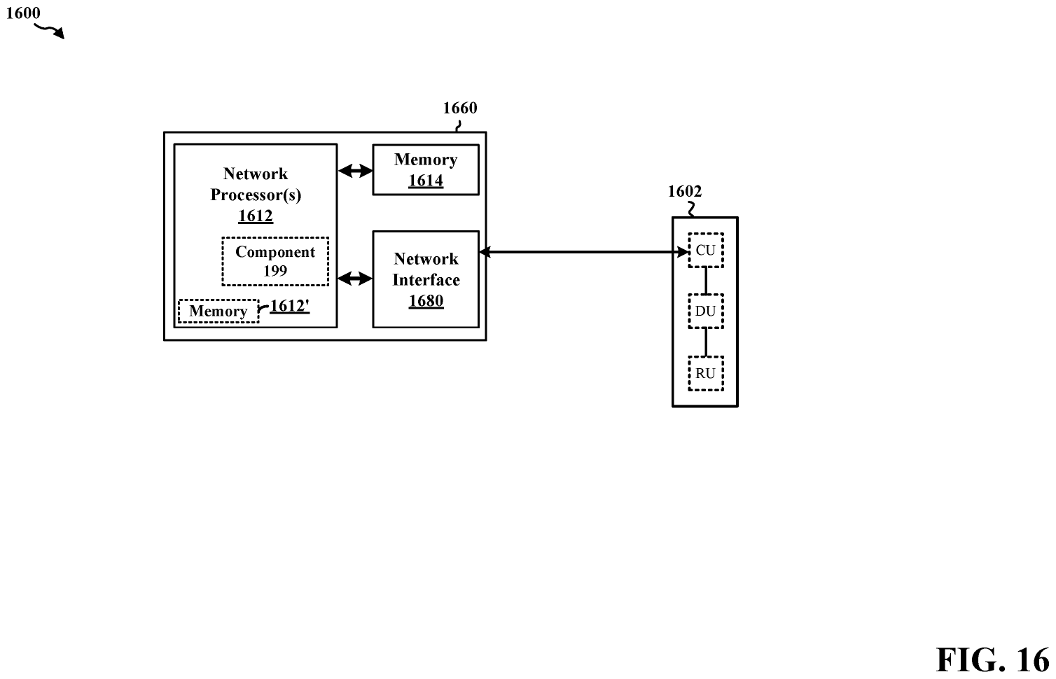

FIG. 16 is a diagram 1600 illustrating an example of a hardware implementation for a network entity 1660. In one example, the network entity 1660 may be within the core network 120. The network entity 1660 may include at least one network processor 1612. The network processor(s) 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU of network entity 1602. The on-chip memory 1612′ and the additional memory modules 1614 may each be considered a computer-readable medium/memory. Each computer-readable medium/memory may be non-transitory. The network processor(s) 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure an MDT configuration. The component 199 may be configured to transmit, for the UE 104, the MDT configuration. The component 199 may be configured to receive at least one of a first indicator of a location of the UE 104 or a second indicator of an MDT uncertainty metric based on the MDT configuration. The component 199 may be within the network processor(s) 1612. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In one configuration, the network entity 1660 may include means for configuring an MDT configuration. The network entity 1660 may include means for transmitting, for a UE, the MDT configuration. The network entity 1660 may include means for receiving at least one of a first indicator of a location of the UE or a second indicator of an MDT uncertainty metric based on the MDT configuration. The MDT configuration may include a signal threshold value. The network entity 1660 may include means for transmitting a pilot signal. The reception of the at least one of the first indicator or the second indicator may be based on the pilot signal and the signal threshold value. The signal threshold value may include at least one of an RSRP threshold value; or an RSSI threshold value. The pilot signal may include at least one of an SSB or a PRS. The network entity 1660 may include means for receiving a UE capability including a third indicator of a sensitivity metric associated with the UE. The network entity 1660 may include means for configuring the MDT configuration by configuring at least one of the signal threshold value or a periodicity threshold of the MDT configuration based on the sensitivity metric. The sensitivity metric may include at least one of (a) a class of the UE, (b) a power level of the UE, (c) a requested accuracy level, (d) a number of Rx chains reported by the UE or (e) a number of Rx antennas used by the UE to receive the pilot signal. The MDT configuration may include a third indicator of a plurality of location calculation occasions. The network entity 1660 may include means for receiving the first indicator of the location of the UE by receiving a fourth indicator of a plurality of locations corresponding to the plurality of location calculation occasions. The plurality of locations may include the location of the UE. The network entity 1660 may include means for calculating a second MDT uncertainty metric based on the plurality of locations corresponding to the plurality of location calculation occasions. The MDT uncertainty metric may include at least one of a time between a location calculation and an MDT measurement or a calculation based on a mobility metric associated with the UE and the time between the location calculation and the MDT measurement. The network entity 1660 may include means for calculating the mobility metric associated with the UE. The network entity 1660 may include means for calculating a second MDT uncertainty metric based on the calculated mobility metric and the time between the location calculation and the MDT measurement. The network entity 1660 may include means for receiving a UE capability including a third indicator of whether the UE is capable of calculating at least one of the location of the UE or the MDT uncertainty metric based on the MDT configuration. The network entity 1660 may include means for configuring the MDT configuration by configuring the MDT configuration based on the UE capability. The MDT configuration may include at least one of (a) a fourth indicator for the UE to configure at least one of a signal threshold value or a periodicity threshold based on a sensitivity metric associated with the UE, (b) a fifth indicator of the UE to configure at least one of the signal threshold value or the periodicity threshold based on a PHR value associated with the UE, (c) or a sixth indicator of the UE to configure at least one of the signal threshold value or the periodicity threshold based on a Doppler spread value associated with the UE. The sensitivity metric may include at least one of (a) a class of the UE, (b) a power level of the UE, (c) a requested accuracy level, (d) a number of Rx chains reported by the UE or (e) a number of Rx antennas used by the UE to measure the calculated location. The network entity 1660 may include means for transmitting a PHR including a seventh indicator of the PHR value. The network entity 1660 may include means for configuring a compliance test for the UE based on the UE capability. The network entity 1660 may include means for transmitting the configured compliance test. The network entity 1660 may include means for receiving a compliance report based on the configured compliance test. The network entity 1660 may include means for increasing an allocation of at least one of an UL resource or a DL resource to the UE based on the MDT configuration. The network entity 1660 may include means for transmitting a transmission schedule based on the increased allocation. The means may be the component 199 of the network entity 1660 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a component of the device. A device configured to “obtain” data, such as a transmission, signal, or message, may receive, for example with a transceiver, may obtain the data from a component of the device, for example a component that receives the data or generates the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: obtaining a minimization of drive test (MDT) configuration; calculating at least one of a location of the UE or an MDT uncertainty metric based on the MDT configuration; and transmitting at least one of a first indicator of the calculated location of the UE or a second indicator of the calculated MDT uncertainty metric.
Aspect 2 is the method of aspect 1, wherein obtaining the MDT configuration comprises receiving, from a network node, the MDT configuration.
Aspect 3 is the method of aspect 2, wherein the MDT configuration comprises a third indicator of a signal threshold value, and wherein calculating at least one of the location of the UE or the MDT uncertainty metric based on the MDT configuration comprises: receiving a pilot signal; measuring the pilot signal; and calculating the location of the UE in response to the measured pilot signal being less than or equal to the signal threshold value.
Aspect 4 is the method of aspect 3, wherein the signal threshold value comprises at least one of: a reference signal received power (RSRP) threshold value; or a reference signal strength indicator (RSSI) threshold value.
Aspect 5 is the method of either of aspects 3 or 4, wherein the pilot signal comprises at least one of: a synchronization signal block (SSB); or a positioning reference signal (PRS).
Aspect 6 is the method of any of aspects 3 to 5, wherein the MDT configuration comprises a fourth indicator of a plurality of location calculation occasions, wherein calculating the location of the UE comprises calculating the location of the UE during each of the plurality of location calculation occasions, and wherein transmitting the first indicator of the calculated location of the UE comprises transmitting a fifth indicator of a plurality of calculated locations corresponding to the plurality of location calculation occasions, wherein the plurality of calculated locations comprises the calculated location of the UE.
Aspect 7 is the method of any of aspects 3 to 6, further comprising transmitting a UE capability comprising a fourth indicator of a sensitivity metric associated with the UE before the reception of the MDT configuration.
Aspect 8 is the method of aspect 7, wherein the sensitivity metric comprises at least one of: a class of the UE; a power level of the UE; a requested accuracy level; a number of receiver (Rx) chains reported by the UE; or a number of Rx antennas used by the UE to receive the pilot signal.
Aspect 9 is the method of any of aspects 2 to 8, wherein the MDT configuration comprises a third indicator of a periodicity threshold, and wherein calculating at least one of the location of the UE or the MDT uncertainty metric based on the MDT configuration comprises periodically calculating the location of the UE based on a clock time of the UE and the periodicity threshold.
Aspect 10 is the method of any of aspects 1 to 9, wherein obtaining the MDT configuration comprises configuring the MDT configuration based on at least one of: a sensitivity metric associated with the UE; a power headroom report (PHR) value associated with the UE; or a Doppler spread value associated with the UE.
Aspect 11 is the method of aspect 10, wherein the sensitivity metric comprises at least one of: a class of the UE; a power level of the UE; a requested accuracy level; a number of receiver (Rx) chains reported by the UE; or a number of Rx antennas used by the UE to measure the calculated location.
Aspect 12 is the method of either of aspects 10 or 11, further comprising receiving a PHR comprising a third indicator of the PHR value before the configuration of the MDT configuration.
Aspect 13 is the method of any of aspects 10 to 12, further comprising: receiving, from a network node, a first pilot signal; receiving, from the network node, a second pilot signal; and calculating the Doppler spread value based on the first pilot signal and the second pilot signal.
Aspect 14 is the method of any of aspects 1 to 13, wherein the MDT uncertainty metric comprises at least one of: a time between a location calculation and an MDT measurement; or a calculation based on a mobility metric associated with the UE and the time between the location calculation and the MDT measurement.
Aspect 15 is the method of any of aspects 1 to 14, further comprising transmitting, before the obtainment of the MDT configuration, a UE capability comprising a third indicator of whether the UE is capable of calculating at least one of the location of the UE or the MDT uncertainty metric based on the MDT configuration.
Aspect 16 is a method of wireless communication at a network node, comprising: configuring a minimization of drive test (MDT) configuration; transmitting, for a user equipment (UE), the MDT configuration; and receiving at least one of a first indicator of a location of the UE or a second indicator of an MDT uncertainty metric based on the MDT configuration.
Aspect 17 is the method of aspect 16, wherein the MDT configuration comprises a signal threshold value, further comprising transmitting a pilot signal, wherein the reception of the at least one of the first indicator or the second indicator is based on the pilot signal and the signal threshold value.
Aspect 18 is the method of aspect 17, wherein the signal threshold value comprises at least one of: a reference signal received power (RSRP) threshold value; or a reference signal strength indicator (RSSI) threshold value.
Aspect 19 is the method of either of aspects 17 to 18, wherein the pilot signal comprises at least one of: a synchronization signal block (SSB); or a positioning reference signal (PRS).
Aspect 20 is the method of any of aspects 17 to 19, further comprising: receiving a UE capability comprising a third indicator of a sensitivity metric associated with the UE, wherein configuring the MDT configuration comprises configuring at least one of the signal threshold value or a periodicity threshold of the MDT configuration based on the sensitivity metric.
Aspect 21 is the method of aspect 20, wherein the sensitivity metric comprises at least one of: a class of the UE; a power level of the UE; a requested accuracy level; a number of receiver (Rx) chains reported by the UE; or a number of Rx antennas used by the UE to receive the pilot signal.
Aspect 22 is the method of any of aspects 16 to 20, wherein the MDT configuration comprises a third indicator of a plurality of location calculation occasions, wherein receiving the first indicator of the location of the UE comprises receiving a fourth indicator of a plurality of locations corresponding to the plurality of location calculation occasions, wherein the plurality of locations comprises the location of the UE.
Aspect 23 is the method of aspect 22, further comprising calculating a second MDT uncertainty metric based on the plurality of locations corresponding to the plurality of location calculation occasions.
Aspect 24 is the method of any of aspects 16 to 23, wherein the MDT uncertainty metric comprises at least one of: a time between a location calculation and an MDT measurement; or a calculation based on a mobility metric associated with the UE and the time between the location calculation and the MDT measurement.
Aspect 25 is the method of aspect 24, further comprising: calculating the mobility metric associated with the UE; and calculating a second MDT uncertainty metric based on the calculated mobility metric and the time between the location calculation and the MDT measurement.
Aspect 26 is the method of any of aspects 16 to 25, further comprising: receiving a UE capability comprising a third indicator of whether the UE is capable of calculating at least one of the location of the UE or the MDT uncertainty metric based on the MDT configuration, wherein configuring the MDT configuration comprises configuring the MDT configuration based on the UE capability.
Aspect 27 is the method of aspect 26, wherein the MDT configuration comprises at least one of: a fourth indicator for the UE to configure at least one of a signal threshold value or a periodicity threshold based on a sensitivity metric associated with the UE; a fifth indicator of the UE to configure at least one of the signal threshold value or the periodicity threshold based on a power headroom report (PHR) value associated with the UE; or a sixth indicator of the UE to configure at least one of the signal threshold value or the periodicity threshold based on a Doppler spread value associated with the UE.
Aspect 28 is the method of aspect 27, wherein the sensitivity metric comprises at least one of: a class of the UE; a power level of the UE; a requested accuracy level; a number of receiver (Rx) chains reported by the UE; or a number of Rx antennas used by the UE to measure the calculated location.
Aspect 29 is the method of either of aspects 27 or 28, further comprising transmitting a PHR comprising a seventh indicator of the PHR value.
Aspect 30 is the method of any of aspects 26 to 29, further comprising: configuring a compliance test for the UE based on the UE capability; transmitting the configured compliance test; and receiving a compliance report based on the configured compliance test.
Aspect 31 is the method of any of aspects 26 to 30, further comprising: increasing an allocation of at least one of an uplink (UL) resource or a downlink (DL) resource to the UE based on the MDT configuration; and transmitting a transmission schedule based on the increased allocation.
Aspect 32 is an apparatus for wireless communication, comprising: at least one memory; and at least one processor coupled to the at least one memory and, based at least in part on information stored in the at least one memory, the at least one processor, individually or in any combination, is configured to perform the method of any of aspects 1 to 31.
Aspect 33 is an apparatus for wireless communication, comprising means for performing each step in the method of any of aspects 1 to 31.
Aspect 34 is the apparatus of any of aspects 1 to 31, further comprising a transceiver (e.g., functionally connected to the at least one processor of Aspect 32) configured to receive or to transmit in association with the method of any of aspects 1 to 31.
Aspect 35 is a computer-readable medium (e.g., a non-transitory computer-readable medium) storing computer executable code, the code when executed by at least one processor causes the at least one processor to perform the method of any of aspects 1 to 31.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
obtain a minimization of drive test (MDT) configuration;
calculate at least one of a location of the UE or an MDT uncertainty metric based on the MDT configuration; and
transmit at least one of a first indicator of the calculated location of the UE or a second indicator of the calculated MDT uncertainty metric.

2. The apparatus of claim 1, wherein, to obtain the MDT configuration, the at least one processor, individually or in any combination, is configured to:
receive, from a network node, the MDT configuration.

3. The apparatus of claim 2, wherein the MDT configuration comprises a third indicator of a signal threshold value, and wherein, to calculate at least one of the location of the UE or the MDT uncertainty metric based on the MDT configuration, the at least one processor, individually or in any combination, is configured to:
receive a pilot signal;
measure the pilot signal; and
calculate the location of the UE in response to the measured pilot signal being less than or equal to the signal threshold value.

4. The apparatus of claim 3, wherein the signal threshold value comprises at least one of:
a reference signal received power (RSRP) threshold value; or
a reference signal strength indicator (RSSI) threshold value.

5. The apparatus of claim 3, wherein the pilot signal comprises at least one of:
a synchronization signal block (SSB); or
a positioning reference signal (PRS).

6. The apparatus of claim 3, wherein the MDT configuration comprises a fourth indicator of a plurality of location calculation occasions, wherein, to calculate the location of the UE, the at least one processor, individually or in any combination, is configured to:
calculate the location of the UE during each of the plurality of location calculation occasions, and wherein, to transmit the first indicator of the calculated location of the UE, the at least one processor, individually or in any combination, is configured to:
transmit a fifth indicator of a plurality of calculated locations corresponding to the plurality of location calculation occasions, wherein the plurality of calculated occasions comprises the calculated location of the UE.

7. The apparatus of claim 3, wherein the at least one processor, individually or in any combination, is further configured to:
transmit a UE capability comprising a fourth indicator of a sensitivity metric associated with the UE before the reception of the MDT configuration.

8. The apparatus of claim 7, wherein the sensitivity metric comprises at least one of:
a class of the UE;
a power level of the UE;
a requested accuracy level;
a number of receiver (Rx) chains reported by the UE; or
a number of Rx antennas used by the UE to receive the pilot signal.

9. The apparatus of claim 2, wherein the MDT configuration comprises a third indicator of a periodicity threshold, and wherein, to calculate at least one of the location of the UE or the MDT uncertainty metric based on the MDT configuration, the at least one processor, individually or in any combination, is configured to:
periodically calculate the location of the UE based on a clock time of the UE and the periodicity threshold.

10. The apparatus of claim 1, wherein, to obtain the MDT configuration, the at least one processor, individually or in any combination, is configured to:
configure the MDT configuration based on at least one of:
a sensitivity metric associated with the UE;
a power headroom report (PHR) value associated with the UE; or
a Doppler spread value associated with the UE.

11. The apparatus of claim 10, wherein the sensitivity metric comprises at least one of:
a class of the UE;
a power level of the UE;
a requested accuracy level;
a number of receiver (Rx) chains reported by the UE; or
a number of Rx antennas used by the UE to measure the calculated location.

12. The apparatus of claim 10, wherein the at least one processor, individually or in any combination, is further configured to:
receive a PHR comprising a third indicator of the PHR value before the configuration of the MDT configuration.

13. The apparatus of claim 10, wherein the at least one processor, individually or in any combination, is further configured to:
receive, from a network node, a first pilot signal;
receive, from the network node, a second pilot signal; and
calculate the Doppler spread value based on the first pilot signal and the second pilot signal.

14. The apparatus of claim 1, wherein the MDT uncertainty metric comprises at least one of:
a time between a location calculation and an MDT measurement; or
a calculation based on a mobility metric associated with the UE and the time between the location calculation and the MDT measurement.

15. The apparatus of claim 1, wherein the at least one processor, individually or in any combination, is further configured to:
transmit, before the obtainment of the MDT configuration, a UE capability comprising a third indicator of whether the UE is capable of calculating at least one of the location of the UE or the MDT uncertainty metric based on the MDT configuration.

16. The apparatus of claim 1, further comprising a transceiver coupled to the at least one processor, wherein the at least one processor, individually or in any combination, is further configured to:
transmit, via the transceiver, at least one of the first indicator of the calculated location of the UE or the second indicator of the calculated MDT uncertainty metric.

17. An apparatus for wireless communication at a network node, comprising:
at least one memory; and
at least one processor coupled to the at least one memory and, based at least in part on information stored in the at least one memory, the at least one processor, individually or in any combination, is configured to:
configure a minimization of drive test (MDT) configuration;
transmit, for a user equipment (UE), the MDT configuration; and
receive at least one of a first indicator of a location of the UE or a second indicator of an MDT uncertainty metric based on the MDT configuration.

18. The apparatus of claim 17, wherein the MDT configuration comprises a signal threshold value, wherein the at least one processor, individually or in any combination, is further configured to:
transmit a pilot signal, wherein the reception of the at least one of the first indicator or the second indicator is based on the pilot signal and the signal threshold value.

19. The apparatus of claim 18, wherein the at least one processor, individually or in any combination, is further configured to:
receive a UE capability comprising a third indicator of a sensitivity metric associated with the UE, wherein, to configure the MDT configuration, the at least one processor, individually or in any combination, is configured to:
configure at least one of the signal threshold value or a periodicity threshold of the MDT configuration based on the sensitivity metric.

20. The apparatus of claim 17, wherein the MDT configuration comprises a third indicator of a plurality of location calculation occasions, wherein, to receive the first indicator of the location of the UE, the at least one processor, individually or in any combination, is configured to:
receive a fourth indicator of a plurality of locations corresponding to the plurality of location calculation occasions, wherein the plurality of locations comprises the location of the UE.

21. The apparatus of claim 20, wherein the at least one processor, individually or in any combination, is further configured to:
calculate a second MDT uncertainty metric based on the plurality of locations corresponding to the plurality of location calculation occasions.

22. The apparatus of claim 17, wherein the MDT uncertainty metric comprises at least one of:
a time between a location calculation and an MDT measurement; or
a calculation based on a mobility metric associated with the UE and the time between the location calculation and the MDT measurement.

23. The apparatus of claim 22, wherein the at least one processor, individually or in any combination, is further configured to:
calculate the mobility metric associated with the UE; and
calculate a second MDT uncertainty metric based on the calculated mobility metric and the time between the location calculation and the MDT measurement.

24. The apparatus of claim 17, wherein the at least one processor, individually or in any combination, is further configured to:
receive a UE capability comprising a third indicator of whether the UE is capable of calculating at least one of the location of the UE or the MDT uncertainty metric based on the MDT configuration, wherein, to configure the MDT configuration, the at least one processor, individually or in any combination, is configured to:
configure the MDT configuration based on the UE capability.

25. The apparatus of claim 24, wherein the MDT configuration comprises at least one of:
a fourth indicator for the UE to configure at least one of a signal threshold value or a periodicity threshold based on a sensitivity metric associated with the UE;
a fifth indicator of the UE to configure at least one of the signal threshold value or the periodicity threshold based on a power headroom report (PHR) value associated with the UE; or
a sixth indicator of the UE to configure at least one of the signal threshold value or the periodicity threshold based on a Doppler spread value associated with the UE.

26. The apparatus of claim 25, wherein the at least one processor, individually or in any combination, is further configured to:
transmit a PHR comprising a seventh indicator of the PHR value.

27. The apparatus of claim 24, further comprising a transceiver coupled to the at least one processor, wherein the at least one processor, individually or in any combination, is further configured to:
configure a compliance test for the UE based on the UE capability;
transmit, via the transceiver, the configured compliance test; and
receive, via the transceiver, a compliance report based on the configured compliance test.

28. The apparatus of claim 24, wherein the at least one processor, individually or in any combination, is further configured to:
increase an allocation of at least one of an uplink (UL) resource or a downlink (DL) resource to the UE based on the MDT configuration; and
transmit a transmission schedule based on the increased allocation.

29. A method of wireless communication at a user equipment (UE), comprising:
obtaining a minimization of drive test (MDT) configuration;
calculating at least one of a location of the UE or an MDT uncertainty metric based on the MDT configuration; and
transmitting at least one of a first indicator of the calculated location of the UE or a second indicator of the calculated MDT uncertainty metric.

30. A method of wireless communication at a network node, comprising:
configuring a minimization of drive test (MDT) configuration;
transmitting, for a user equipment (UE), the MDT configuration; and
receiving at least one of a first indicator of a location of the UE or a second indicator of an MDT uncertainty metric based on the MDT configuration.
